(19) United States
(12) Patent Application Publication
(10) Pub. No.: US 2026/0028495 A1
(43) Pub. Date: Jan. 29, 2026

(54) Recording Method And Recording Apparatus

(71) Applicant: SEIKO EPSON CORPORATION, Tokyo (JP)

(72) Inventors: Sena GOZU, Shiojiri (JP); Kentaro HARA, Shiojiri (JP)

(21) Appl. No.: 19/279,009

(22) Filed: Jul. 24, 2025

(30) Foreign Application Priority Data
Jul. 26, 2024 (JP) 2024-120933

(51) Int. Cl. C09D 11/322; B41J 2/21; C09D 11/037; C09D 11/38; C09D 11/40

(52) U.S. Cl. CPC C09D 11/322; B41J 2/2103; B41J 2/2107; C09D 11/037; C09D 11/38; C09D 11/40

(57) ABSTRACT

A recording method includes: a transporting step of transporting a recording medium; and an ink deposition step of ejecting an ink composition from an ink jet head to deposit the ink composition onto the recording medium transported in the transporting step, in which the ink jet head is a line head having a length equal to or longer than a recording region of the recording medium in a direction intersecting the transport direction; the ink composition includes a first ink that contains an azo-based pigment and is a red-based ink, and a second ink that contains a pigment and is a chromatic ink other than the red-based ink; each of the first ink and the second ink is an aqueous ink; in the line head, multiple first nozzles ejecting the first ink are arranged in the direction intersecting the transport direction, and multiple second nozzles ejecting the second ink are arranged in the direction intersecting the transport direction; the line head has a portion in which a time difference between landing of the first ink and landing of the second ink on the recording medium varies between portions of the line head in the direction intersecting the transport direction; and at least one of the first ink and the second ink has a thickening ratio of less than 2.0 when the ink is mixed with an aqueous calcium propionate solution having a Ca concentration of 0.3 mol/L at a mass ratio of 10:1.

The present application is based on, and claims priority from JP Application Serial Number 2024-120933, filed Jul. 26, 2024, the disclosure of which is hereby incorporated by reference herein in its entirety.

### BACKGROUND

### 1. Technical Field

The present disclosure relates to a recording method and a recording apparatus.

### 2. Related Art

Ink jet recording methods can record high-resolution images with a relatively simple apparatus and are rapidly developed in various fields. For example, JP-A-2023-135219 discloses a recording apparatus provided with a line head. The recording apparatus disclosed in JP-A-2023-135219 has a certain head arrangement and may cause color unevenness or the like in a printed material, and for the purpose of reducing the color unevenness or the like, JP-A-2023-135219 discloses a recording method in which an ink composition containing inorganic oxide particles is used to reduce a color difference in the width direction intersecting the scanning direction of an obtained recorded material.

A recording apparatus having a line head is suitable for high-speed printing. Problems with a recording method using a recording apparatus having a line head is to suppress an appearance of a portion having a color difference in an image and to improve the color developability of a red image.

### SUMMARY

An aspect of a recording method according to the present disclosure is a method including: a transporting step of transporting a recording medium in a transport direction; and an ink deposition step of ejecting an ink composition from an ink jet head to deposit the ink composition onto the recording medium transported in the transporting step, in which the ink jet head is a line head having a length equal to or longer than a recording region of the recording medium in a direction intersecting the transport direction, the ink composition includes a first ink that contains an azo-based pigment and is a red-based ink, and a second ink that contains a pigment and is a chromatic ink other than the red-based ink, each of the first ink and the second ink is an aqueous ink, in the line head, a plurality of first nozzles ejecting the first ink is arranged in the direction intersecting the transport direction, and a plurality of second nozzles ejecting the second ink is arranged in the direction intersecting the transport direction, the line head has a portion in which a time difference between landing of the first ink and landing of the second ink on the recording medium varies between portions of the line head in the direction intersecting the transport direction, and at least one of the first ink and the second ink has a thickening ratio of less than 2.0 when the first ink or the second ink is mixed with an aqueous calcium propionate solution having a Ca concentration of 0.3 mol/L at a mass ratio of 10:1.

Another aspect of the present disclosure is a recording apparatus which performs the above-described recording method, the recording apparatus including: the ink composition; a transporting mechanism which performs the transporting step; and the ink jet head.

### BRIEF DESCRIPTION OF THE DRAWINGS

FIG. 1 is a schematic cross-sectional view of a recording apparatus capable of being used in a recording method according to an embodiment.

FIG. 2 is a schematic view of an example of an ink jet head having portions with different inter-nozzle distances.

FIG. 3 is a schematic view of an example of another ink jet head.

FIG. 4 is Table 1 showing compositions and evaluation results of inks used in Examples.

FIG. 5 is Table 2 showing compositions and evaluation results of inks used in Examples, Comparative Examples, and Reference Example.

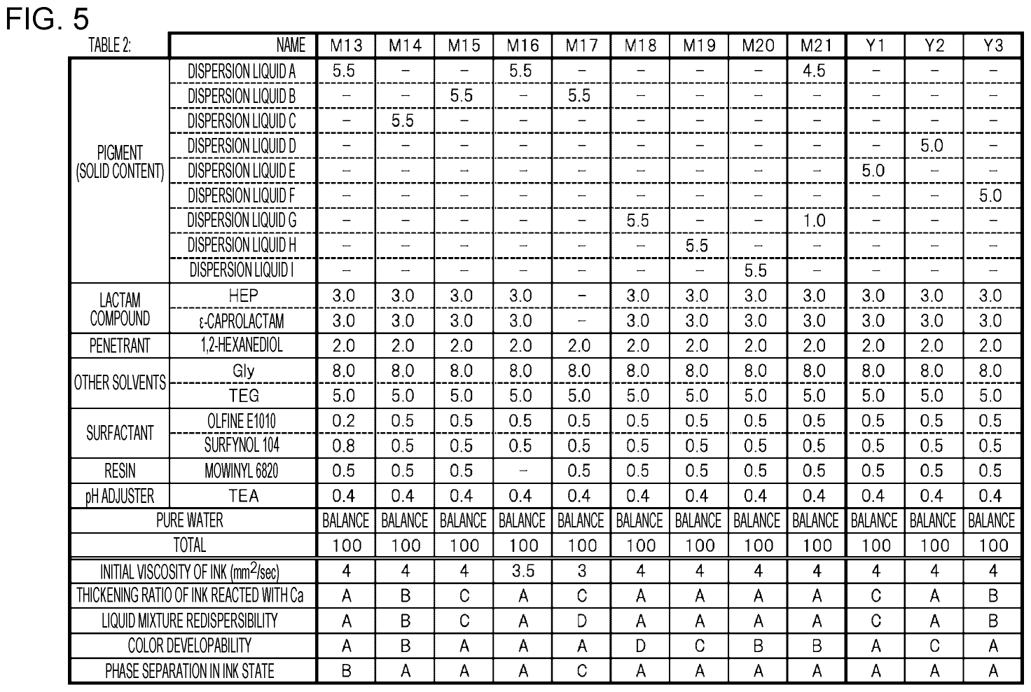

FIG. 6 is Table 3 showing conditions and evaluation results of Examples.

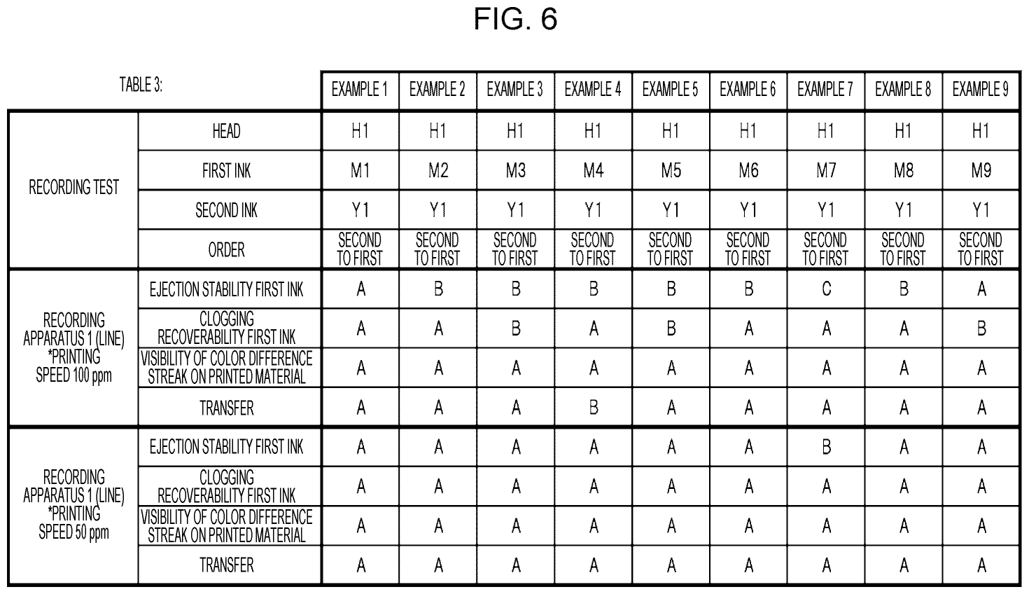

FIG. 7 is Table 4 showing conditions and evaluation results of Examples.

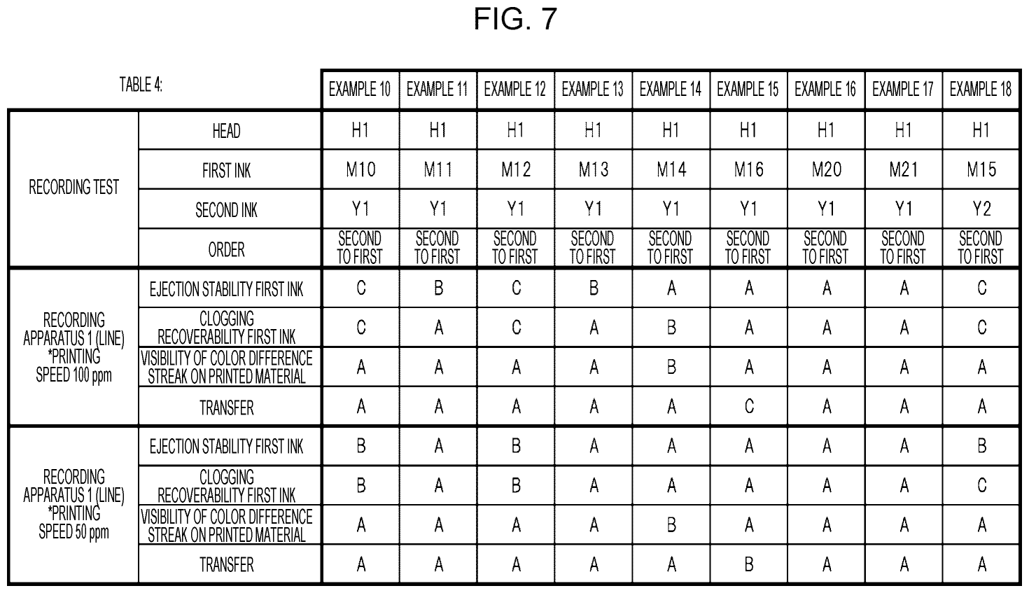

FIG. 8 is Table 5 showing conditions and evaluation results of Examples, Comparative Examples and Reference Example.

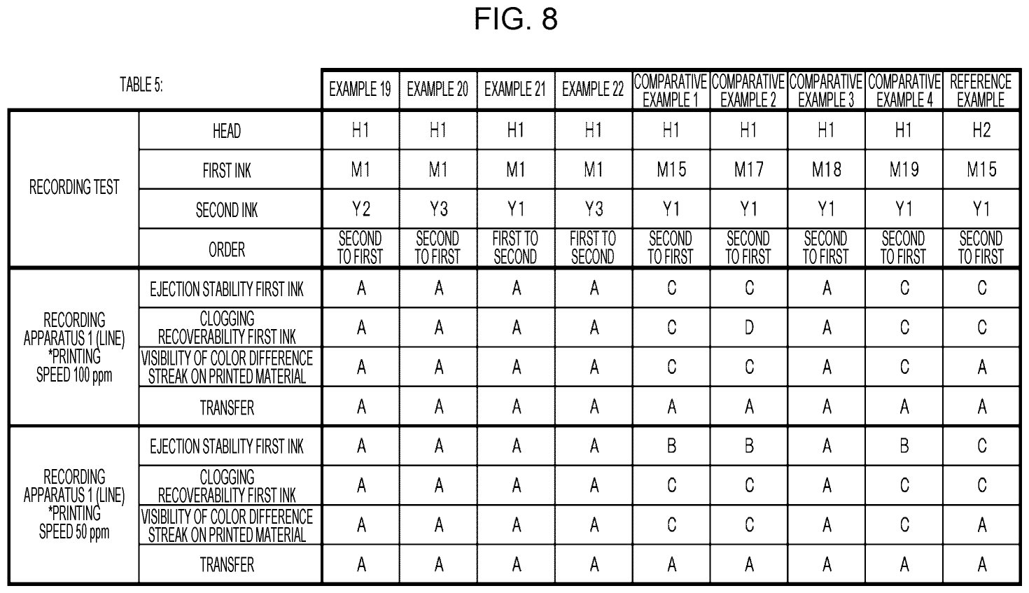

### DESCRIPTION OF EMBODIMENTS

Embodiments of the present disclosure will be described below. The embodiments described below describe examples of the present disclosure. The present disclosure is not limited to the following embodiments, and also includes various modifications implemented within a range not changing the spirit of the present disclosure. It should be noted that not all configurations described below are essential configurations of the present disclosure.

### 1. RECORDING METHOD

A recording method according to the present embodiment includes a transporting step of transporting a recording medium, and an ink deposition step of ejecting an ink composition from an ink jet head to deposit the ink composition onto the recording medium transported in the transport step.

A recording apparatus having a line head is suitable for high-speed printing. In the line head, a plurality of unit heads is often arranged side by side. In particular, the line head having such a configuration is useful in a case where the length of the line head in the transport direction is shortened in a line head using inks of a plurality of colors to realize a space-saving line printer.

However, depending on the configuration and arrangement of the unit heads, in the line head, a portion in which the inter-nozzle distance between a nozzle for a first ink and a nozzle for a second ink in the transport direction (scanning direction) of the recording medium varies may be generated. In this case, a portion in which a time difference between landing of the first ink and landing of the second ink on the same portion of the recording medium varies is generated.

In the case of such a line head, when the line head is viewed in the recording medium transport direction (scanning direction), in an obtained image, in the width direction intersecting the transport direction, a portion having different colors is generated between portions having different landing time differences, and thus, a portion having a color difference may appear in the image in a band shape or a stripe shape. Such a color difference is referred to as a color difference streak.

According to the present embodiment, color difference streaks can be reduced, and an image excellent in color developability can be obtained. Aspects of the ink composition, recording medium, steps of the recording method, and recording will be described below, and an outline of a recording apparatus such as an ink jet head will be described later.

### 1. 1. Ink Composition

The ink composition used in the recording method of the present embodiment includes a first ink which contains an azo-based pigment and is a red-based ink, and a second ink which contains a pigment and is a chromatic ink other than the red-based ink. Each of the first ink and the second ink is an aqueous ink.

### 1. 1. 1. First Ink

The first ink is a red-based ink containing an azo-based pigment. The red-based ink is an ink which is mainly used to express a red color in a case where printing for reproducing a secondary color or higher-order color is performed using a plurality of color inks. For example, a magenta ink, a red ink, or a similar ink may be used.

The red-based ink is preferably a magenta ink. Here, the magenta ink generally means an ink used as an ink set together with a cyan ink, a yellow ink, and if necessary, a black ink. For example, an ink that is commonly labeled as magenta ink in a commercially available ink cartridge, and an ink generally perceived to be magenta ink are included.

The red color refers to a color having a hue angle within a predetermined range in the L*a*b*color system standardized by International Commission on Illumination (CIE). The hue angle of the red color is preferably 5° or more and 60° or less, 15° or more and 50° or less, or 250 or more and 40° or less. The red-based ink is an ink mainly used when printing the red color. An ink capable of expressing the red color by itself is preferable.

### (1) Azo-Based Pigment

The first ink contains an azo-based pigment. Examples of the azo-based pigment include a monoazo pigment, a disazo pigment, a condensed disazo pigment, and a benzimidazolone pigment. The azo-based pigment contained in the first ink is an azo-based pigment that makes the first ink a red-based ink, and is a red azo-based pigment. For example, in a case of an ink containing only the azo-based pigment as a coloring material, the azo-based pigment is an azo-based pigment that makes the ink a red-based ink.

As the azo-based pigment, it is possible to use a pigment which is an azo pigment and which can form an ink as a red-based ink. Specific examples of the azo-based pigment include C.I. Pigment Red 5, C.I. Pigment Red 17, C.I. Pigment Red 22, C.I. Pigment Red 31, C.I. Pigment Red 48:1, C.I. Pigment Red 48:2, C.I. Pigment Red 53:1, C.I. Pigment Red 57:1, C.I. Pigment Red 114, C.I. Pigment Red 146, C.I. Pigment Red 185, C.I. Pigment Red 150, C.I. Pigment Red 170, C.I. Pigment Red 184, C.I. Pigment Red 185, C.I. Pigment Red 208, C.I. Pigment Red 245, C.I. Pigment Red 268, C.I. Pigment Red 269, and solid solutions thereof.

The azo-based pigment is preferably selected from among the above examples, particularly, C.I. Pigment Red 150, C.I. Pigment Red 269, C.I. Pigment Red 17, and solid solutions thereof because an image having more excellent color developability can be obtained.

In addition, as an example of the azo-based pigment, a pigment having a chemical structure represented by the following Formula (I) can be exemplified and is preferable.

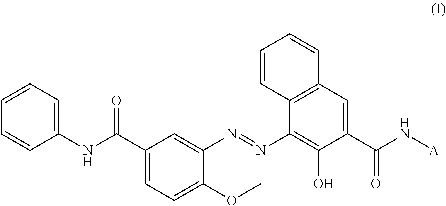

In Formula (I), A represents a hydrogen atom or an aromatic group.

Here, the aromatic group is a group having an aromatic ring such as a benzene ring or a naphthalene ring, and the aromatic ring may be substituted or unsubstituted. In addition, the aromatic ring is directly bonded to a nitrogen atom to which the aromatic group is bonded. Further, in a case where the aromatic ring has a substituent, the substituent is not particularly limited and is, for example, an organic group or an inorganic group, and the number of substituents can also be arbitrarily selected. Examples of the substituent include, but are not limited to, an alkyl group, a halo group, an alkoxy group, a hydroxy group, a carboxy group, an amino group, and a nitro groups.

When the azo-based pigment is selected from the pigment having the chemical structure represented by the Formula (I) and a solid solution thereof, an image having more excellent color developability can be obtained.

The azo-based pigment may be a resin-dispersed pigment in which the azo-based pigment is dispersed with a resin described later, or may be a self-dispersible pigment in which a surface of the pigment is treated to introduce a functional group, and is preferably a resin-dispersed pigment.

The volume-average particle diameter D50 of the azo-based pigment is preferably 110 nm or less. The volume-average particle diameter D50 of the azo-based pigment can be measured by a particle size distribution measuring apparatus. Examples of the particle size distribution measuring apparatus include a particle size distribution meter (for example, “NANOTRAC series” manufactured by MicrotracBEL Corp.) using a dynamic light scattering method as a measuring principle. A D50 value is taken as the volume-average particle diameter.

The volume-average particle diameter of the azo-based pigment is preferably 10 nm or more and 110 nm or less, more preferably 50 nm or more and 110 nm or less, still more preferably 80 nm or more and 110 nm or less, yet still more preferably 80 nm or more and less than 110 nm, and particularly preferably 80 nm or more and 100 nm or less.

When the volume-average particle diameter of the azo-based pigment is within the above ranges, dispersion stability of the pigment is favorable, color developability is more favorable, and sedimentation of components during storage is further suppressed.

The content of the azo-based pigment is preferably 1% by mass or more with respect to the total mass of the composition. The content is more preferably 1% to 10% by mass, preferably 3% by mass or more and 8% by mass or less, more preferably 3% by mass or more and 7% by mass or less, still more preferably 3% by mass or more and 7% by mass or less. The content is further preferably 5% by mass or more and 7% by mass or less, and still further preferably 5.5% by mass or more and 7% by mass or less. When the content of the azo-based pigment is within these ranges, an image having more excellent color developability can be obtained.

### (2) Other Components

Pigment Other than Azo-Based Pigment

The first ink may contain a magenta pigment other than the azo-based pigment within a range in which the first ink can be a magenta ink, a red ink, or an ink similar thereto (that is, a red-based ink). Examples of such pigments include C.I. Pigment Red 1, 2, 3, 4, 6, 7, 8, 9, 10, 11, 12, 14, 15, 16, 18, 19, 21, 23, 30, 32, 37, 38, 40, 41, 42, 88, 112, 122, 123, 144, 149, 166, 168, 171, 175, 176, 177, 178, 179, 187, 202, 209, 219, 224, or C.I. Pigment Violet 19, 23, 32, 33, 36, 38, 43, 50. As a pigment other than the azo-based pigment, a quinacridone-based pigment is preferable.

In a case where the first ink contains these pigments, the content of the azo-based pigment is preferably 30% by mass or more with respect to the total pigment mass contained in the first ink. The content is more preferably 50% by mass or more, preferably 70% by mass or more, preferably 80% by mass or more, and preferably 90% by mass or more. The upper limit is 100% by mass or less, and is not limited, but may be 90% by mass or less, or may be 85% by mass or less. A case where the content is equal to or more than the above ranges is preferable because color developability is more excellent. A case where the content is equal to or less than the above ranges is preferable in terms of the degree of freedom of ink design and low cost.

When the first ink contains the azo-based pigment, the color developability of the first ink can be further enhanced. For example, in a case where the first ink is an ink having low reactivity with calcium ions, the ink easily permeates into the recording medium and is not easily retained on a surface of the recording medium, and thus color developability of the ink becomes low. There are various kinds of pigments suitable for the red-based ink, and the azo-based pigment tends to be excellent in color developability among them. By using the azo-based pigment in the first ink, even when reactivity of the first ink with calcium ions is low, a red-based ink having high color developability can be obtained.

The color of the first ink is not limited, but the first ink is, for example, a magenta ink of a process color ink. In particular, in business applications, high visibility of a red mark on a recorded material such as confidential display or seal printing is required, and a magenta ink used for this color is required to have high color developability. In addition, since red is a color that is easily visually recognized, color difference streaks are easily conspicuous. Therefore, it is required to reduce color difference streaks in color recording using a magenta ink, and the present disclosure exhibits a more excellent effect in this respect.

### Water

The first ink is an aqueous red-based ink (for example, a magenta ink). “Aqueous” means containing water as one main solvent component. According to this configuration, it is possible to perform recording with a reduced environmental load and less odor or the like.

Water is a component which is contained as a main solvent component of the ink and is evaporated and scattered by drying. Water is preferably pure water or ultrapure water from which ionic impurities have been removed as much as possible, such as ion-exchanged water, ultrafiltered water, reverse osmosis water, or distilled water. Use of water sterilized by, for example, ultraviolet irradiation or addition of hydrogen peroxide is advantageous because it is possible to suppress generation of molds or bacteria when the ink is stored for a long period of time.

The content of water is preferably 45% by mass or more, more preferably 50% by mass or more and 98% by mass or less, and still more preferably 55% by mass or more and 95% by mass or less with respect to the total amount of the ink. The content is further preferably 65% by mass or more and 90% by mass or less, and still further preferably 70% by mass or more and 85% by mass or less. A case where the content of water is equal to or more than the above ranges is preferable because drying properties of the ink are excellent, and an image of a recorded material can be prevented from being rubbed and stained.

### Organic Solvent

The first ink may contain an organic solvent. Such an organic solvent is preferably water-soluble. One function of the organic solvent is to improve wettability of the ink with respect to the recording medium or to increase moisture-retaining properties of the ink.

Examples of the organic solvent include polyhydric alcohols, esters, alkylene glycol ethers, cyclic esters, nitrogen-containing solvents, and polyhydric alcohols. Examples of the nitrogen-containing solvents include cyclic amides and acyclic amides. Examples of the acyclic amides include alkoxyalkylamides.

Examples of the esters include glycol monoacetates such as ethylene glycol monomethyl ether acetate, ethylene glycol monoethyl ether acetate, and ethylene glycol monobutyl ether acetate; and glycol diesters such as ethylene glycol diacetate, diethylene glycol diacetate, and propylene glycol diacetate.

The alkylene glycol ethers may be alkylene glycol monoethers or diethers, and are preferably alkyl ethers. Specific examples thereof include alkylene glycol monoalkyl ethers such as ethylene glycol monomethyl ether, ethylene glycol monoethyl ether, ethylene glycol monoisopropyl ether, ethylene glycol monobutyl ether, diethylene glycol monomethyl ether, triethylene glycol monoethyl ether, and triethylene glycol monobutyl ether; and alkylene glycol dialkyl ethers such as ethylene glycol dimethyl ether, ethylene glycol diethyl ether, ethylene glycol dibutyl ether, diethylene glycol dimethyl ether, diethylene glycol diethyl ether, and triethylene glycol diethyl ether.

Examples of the cyclic esters include cyclic esters (lactones) such as β-propiolactone, γ-butyrolactone, δ-valerolactone, ε-caprolactone, and β-butyrolactone; and a compound in which a hydrogen atom of a methylene group adjacent to a carbonyl group of any of the cyclic esters is substituted with an alkyl group having 1 to 4 carbon atoms.

Examples of the alkoxyalkylamides include 3-methoxy-N,N-dimethylpropionamide, 3-methoxy-N,N-diethylpropionamide, 3-methoxy-N,N-methylethylpropionamide, 3-ethoxy-N,N-dimethylpropionamide, 3-ethoxy-N,N-diethylpropionamide, 3-ethoxy-N,N-methylethylpropionamide, 3-n-butoxy-N,N-dimethylpropionamide, 3-n-butoxy-N,N-diethylpropionamide, and 3-n-butoxy-N,N-methylethylpropionamide.

Examples of the cyclic amides include lactams, and examples thereof include pyrrolidones such as 2-pyrrolidone, 1-methyl-2-pyrrolidone, 1-ethyl-2-pyrrolidone, 1-propyl-2-pyrrolidone, and 1-butyl-2-pyrrolidone.

Examples of the polyhydric alcohols include 1,2-alkanediol and other polyhydric alcohols (polyols) (for example, diethylene glycol, triethylene glycol, dipropylene glycol, 1,3-propanediol, 1,3-butanediol (another name: 1, 3-butylene glycol), 1,5-pentanediol, 1,6-hexanediol, 2-ethyl-2-methyl-1, 3-propanediol, 2-methyl-2-propyl-1,3-propanediol, 2-methyl-1,3-propanediol, 2,2-dimethyl-1,3-propanediol, 3-methyl-1,3-butanediol, 2-ethyl-1,3-hexanediol, 3-methyl-1,5-pentanediol, 2-methylpentane-2,4-diol, trimethylolpropane, and glycerin)).

Among the polyhydric alcohols, alkanediols are exemplified. Among the alkanediols, those particularly suitable for enhancing permeability of the ink are exemplified. Examples of such alkanediols include 1,2-alkanediols.

Examples of the 1,2-alkanediols include 1,2-butanediol, 1,2-pentanediol, 1,2-hexanediol, 1,2-heptanediol, and 1,2-octanediol having 4 or more and 8 or less carbon atoms. These may have a branch in the alkane moiety, but are more preferably linear. The 1,2-alkanediols are more preferable because the 1,2-alkanediols have a high function as a penetrant.

Examples of the polyhydric alcohols also include an alkanediol of an alkane having 4 or less carbon atoms and an intermolecular condensate of hydroxy groups of alkanediols of alkanes each having 4 or less carbon atoms. The number of carbon atoms of the alkane is preferably 2 or 3. In the case of the intermolecular condensate, the intermolecular condensation number is 2 or more, preferably 4 or less, and more preferably 3 or less. In addition, as the polyhydric alcohols, polyhydric alcohols of triol or more are also included. The number of hydroxy groups in the molecule of the polyhydric alcohol is 2 or more, preferably 5 or less, and more preferably 3 or less. These polyhydric alcohols are preferred because of their excellent moisture-retaining properties, in particular. The polyhydric alcohols may be used alone or in combination of two or more thereof.

In a case where the ink contains the organic solvent, the organic solvent may be used alone or in combination of two or more thereof. In addition, the total content of the organic solvent with respect to the total mass of the ink is, for example, 5% by mass or more and 50% by mass or less, preferably 10% by mass or more and 45% by mass or less, more preferably 15% by mass or more and 40% by mass or less, and still more preferably 16% by mass or more and 40% by mass or less. The content is further preferably 17% by mass to 30% by mass, and still further preferably 18% by mass to 25% by mass.

When the content of the organic solvent is within the above ranges, the balance between wet spreadability and dryness is further improved, and an image having high image quality is easily formed.

### Lactams

The first ink more preferably contains a lactam (lactam-based compound). The lactam may be the above-described organic solvent or may not be an organic solvent. The lactam may be the above-described cyclic amide.

The lactam-based compound has a structure in which a carboxy group and an amino group in the molecule form a ring by a dehydration condensation reaction. In a case where the lactam is included, redispersibility, phase separation suppression, ejection stability, clogging recoverability, and the like tend to be more excellent. This is presumed to be due to the particularly excellent moisture-retaining properties of lactams.

In addition, by containing the lactam-based compound, compatibility of a surfactant, particularly an acetylene glycol-based surfactant, with the ink composition tends to be further improved. From these viewpoints, the lactam-based compound preferably has a 4- to 8-membered lactam ring, more preferably has a 5- to 8-membered lactam ring, and still more preferably has a 6- to 8-membered lactam ring. Alternatively, those having a 4- or 5-membered lactam ring are also preferred.

From these viewpoints, the molecular weight of the lactam is preferably 80 or more. The molecular weight of the lactam is more preferably 100 or more. The molecular weight of the lactam is more preferably from 100 to 300, and still more preferably from 110 to 200.

The lactam-based compound may be used alone or in combination of two or more thereof. It is also preferable to use a lactam having a 4- or 5-membered lactam ring and a lactam having a 6- to 8-membered lactam ring in combination.

Specific examples of the lactam-based compound include ε-caprolactam (CPL), N-hydroxyethylpyrrolidone (HEP), δ-valerolactam, and N-methyl-2-piperidone, in addition to the cyclic amides described above, and it is preferable to contain ε-caprolactam (CPL), N-hydroxyethylpyrrolidone (HEP), or the like. By containing these compounds, clogging recoverability, color developability, and ejection stability tend to be further improved.

In a case where the lactam-based compound is contained, the content thereof is preferably 0.1% by mass or more and 15% by mass or less, and 0.5% by mass or more and 10% by mass or less, with respect to the total mass of the ink. Further, the content is preferably 1% by mass to 8% by mass, and more preferably 2% by mass to 7% by mass.

In addition, the content of lactam having a 6- to 8-membered lactam ring may be within the above ranges, and is more preferably 1% by mass to 5% by mass, and more preferably 2% by mass to 4% by mass. When the content of the lactam-based compound is within the above ranges, clogging recoverability, color developability, and ejection stability tend to be further improved.

Since the line printer prints continuously at high speed and in a large volume, a large amount of paper dust is generated, and paper dust may accumulate inside the printer. For this reason, the paper dust adheres to the nozzles to increase the viscosity, and ejection stability and clogging recoverability tend to be problems. This tendency is particularly noticeable when the ink is highly reactive with calcium, but this tendency is also observed even in a case where the ink is less reactive. When the ink is less reactive with calcium, ejection stability and clogging recoverability are excellent. When the paper dust generated during recording comes into contact with the ink in the nozzles, the pigment of the highly reactive ink may turn into foreign matter due to the paper dust. As a result, ejection stability and clogging recoverability may deteriorate. When the ink has low reactivity, this can be suppressed.

According to this recording method, drying of the mixture of the paper dust and the ink in the nozzles is suppressed by the moisture-retaining effect of the lactam, and even when the mixture begins to dry, redispersibility of the dried material can be further improved, and ejection stability and clogging recoverability can be improved. Further, this effect is more effective when the molecular weight is equal to or more than a predetermined value.

In addition, in a case where the ink contains the acetylene glycol-based surfactant, the acetylene glycol-based surfactant has low solubility in water, and phase separation may occur particularly when the ink is dried in the nozzles. In addition, an acetylene glycol-based surfactant having a low HLB has particularly excellent permeability, but has low solubility in water and easily cause phase separation. In such a case, the lactam tends to prevent phase separation due to the acetylene glycol-based surfactant insoluble in water. Among lactams, 1-(2-hydroxyethyl)-2-pyrrolidone (HEP) and ε-caprolactam (HEP) exhibit the above effect more remarkably. In particular, even when HEP is contained in the ink, the viscosity of the ink tends to be less likely to increase, and thus the ink ejection amount can be easily controlled and stable ejection can be performed. In addition, CPL is particularly excellent in the above-mentioned effect of redispersibility.

### Surfactant

The ink may contain a surfactant. The surfactant has a function of adjusting the surface tension of the ink and adjusting, for example, wettability with the recording medium. Among surfactants, for example, an acetylene glycol-based surfactant, a silicone-based surfactant, and fluorine-based surfactant can be preferably used.

The acetylene glycol-based surfactant is not particularly limited, and examples thereof include SURFYNOL 104, 104E, 104H, 104A, 104BC, 104DPM, 104PA, 104PG-50, 104S, 420, 440, 465, 485, SE, SE-F, 504, 61, DF37, CT111, CT121, CT131, CT136, TG, GA, and DF110D (which are all trade names, manufactured by Air Products and Chemicals. Inc.), OLFINE B, Y, P, A, STG, SPC, E1004, E1010, PD-001, PD-002W, PD-003, PD-004, EXP. 4001, EXP. 4036, EXP. 4051, AF-103, AF-104, AK-02, SK-14, and AE-3 (which are all trade names, manufactured by Nissin Chemical Industry Co., Ltd.), and ACETYLENOL E00, E00P, E40, and E100 (which are all trade names, manufactured by Kawaken Fine Chemicals Co., Ltd.).

The acetylene glycol-based surfactant has a high effect of enhancing the ink permeability into the recording medium (particularly, plain paper), is unlikely to foam, and is particularly useful in plain paper printing. In plain paper printing by a high-speed line printer, when ink permeation into the recording medium is slow, there is a problem of transfer contamination. After the ink is deposited onto the recording medium, the recording medium is immediately transported, and a roller comes into contact with a recording surface, or the recording medium is stacked on a paper discharge tray, resulting in transfer contamination. However, when the acetylene glycol-based surfactant is used, the permeation of the ink into the recording medium is enhanced, and transfer contamination can be suppressed.

The acetylene glycol-based surfactant is more excellent in permeability into the recording medium and thus is preferable. On the other hand, solubility in water tends to be low, phase separation is likely to occur in the ink, and compatibility with the ink composition tends to be particularly poor.

Among acetylene glycol-based surfactants, those having an HLB value of 6 or less exhibit this tendency particularly strongly. In a case where the ink composition contains the acetylene glycol-based surfactant, particularly an acetylene glycol-based surfactant having an HLB value of 6 or less, the ink preferably contains the above-described lactam. The lower limit of the HLB value is 0 or more, preferably 1 or more, and more preferably 2 or more. Further, the HLB value is more preferably 5 or less.

Further, among acetylene glycol-based surfactants, those having an HLB value of more than 6 tend to have slightly higher solubility in water than those having an HLB value of 6 or less. For this reason, it is preferable to include each of an acetylene glycol-based surfactant having an HLB value of 6 or less and an acetylene glycol-based surfactant having an HLB value of more than 6, it is more preferable to include each of an acetylene glycol-based surfactant having an HLB value of 5 or less and an acetylene glycol-based surfactant having an HLB value of 7 or more, and it is still more preferable to include each of an acetylene glycol-based surfactant having an HLB value of 5 or less and an acetylene glycol-based surfactant having an HLB value of 10 or more. In this case, wettability, clogging recoverability, ejection stability, and the like are more excellent, and suppression of phase separation is also more excellent, which is preferable. The upper limit of the HLB is 20 or less, and preferably 15 or less.

“Hydrophilic lipophilic balance (HLB) value” is a value calculated by the Griffin's method.

The silicone-based surfactant is not particularly limited, and examples thereof preferably include a polysiloxane-based compound. The polysiloxane-based compound is not particularly limited, and examples thereof include polyether-modified organosiloxane. Examples of commercially available products of the polyether-modified organosiloxane include BYK-306, BYK-307, BYK-333, BYK-341, BYK-345, BYK-346, and BYK-348 (which are all trade names, manufactured by BYK Japan KK), KF-351A, KF-352A, KF-353, KF-354L, KF-355A, KF-615A, KF-945, KF-640, KF-642, KF-643, KF-6020, X-22-4515, KF-6011, KF-6012, KF-6015, and KF-6017 (which are all trade names, manufactured by Shin-Etsu Chemical Co., Ltd.), and Silface SAG002, 005, 503A, 008 (which are all trade names, manufactured by Nissin Chemical Industry Co., Ltd.).

As the fluorine-based surfactant, a fluorine-modified polymer is preferably used, and specific examples thereof include BYK-3440 (manufactured by BYK Japan KK), SURFLON S-241, S-242, and S-243 (which are all trade names, manufactured by AGC SEIMI CHEMICAL CO., LTD.), and FTERGENT 215M (manufactured by NEOS COMPANY LIMITED).

When the surfactant is contained in the ink, a plurality of surfactants may be contained. In a case where the surfactant is contained in the ink, the content thereof can be set to 0.1% by mass or more and 2% by mass or less, preferably 0.4% by mass or more and 1.5% by mass or less, and more preferably 0.5% by mass or more and 1.0% by mass or less with respect to the total mass of the ink.

### Resins

The ink may contain resins such as a resin dispersant and a fixing resin.

### Resin Dispersant

It is preferable that the azo-based pigment can be stably dispersed in a dispersion medium, and for this purpose, the azo-based pigment may be dispersed using a dispersant. Examples of the dispersant include a resin dispersant, and the dispersant is selected from dispersants capable of improving dispersion stability of the azo-based pigment.

Examples of the resin dispersant (dispersant resin) include (meth)acrylic resins such as poly(meth)acrylic acid, (meth)acrylic acid-acrylonitrile copolymers, (meth)acrylic acid-(meth)acrylic acid ester copolymers, vinyl acetate-(meth)acrylic acid ester copolymers, vinyl acetate-(meth)acrylic acid copolymers, and vinyl naphthalene-(meth)acrylic acid copolymers, and salts thereof; styrene-based resins such as styrene-(meth)acrylic acid copolymers, styrene-(meth)acrylic acid-(meth)acrylic acid ester copolymers, styrene-α-methylstyrene-(meth)acrylic acid copolymers, styrene-α-methylstyrene-(meth)acrylic acid-(meth)acrylic acid ester copolymers, styrene-maleic acid copolymers, and styrene-maleic acid anhydride copolymers, and salts thereof; urethane-based resins, which are polymer compounds (resins) having a urethane bond formed when an isocyanate group reacts with a hydroxy group, and which may be linear and/or branched regardless of whether being crosslinked or not, and salts thereof; polyvinyl alcohols; vinyl naphthalene-maleic acid copolymers and salts thereof; vinyl acetate-maleic acid ester copolymers and salts thereof; and water-soluble resins such as vinyl acetate-crotonic acid copolymers and salts thereof. Among these, a copolymer of a monomer having a hydrophobic functional group and a monomer having a hydrophilic functional group, and a polymer including a monomer having both a hydrophobic functional group and a hydrophilic functional group are preferable. As the form of the copolymer, any form of a random copolymer, a block copolymer, an alternating copolymer, and a graft copolymer can be used.

Examples of commercially available products of the styrene-based resin dispersants include X-200, X-1, X-205, X-220, and X-228 (manufactured by SEIKO PMC CORPORATION), NOPCOSPERSE (registered trademark) 6100 and 6110 (manufactured by SAN NOPCO LIMITED), JONCRYL 67, 586, 611, 678, 680, 682, and 819 (manufactured by BASF SE), DISPER BYK-190 (manufactured by BYK Japan KK), and N-EA137, N-EA157, N-EA167, N-EA177, N-EA197D, N-EA207D, and E-EN10 (manufactured by DKS Co., Ltd.).

In addition, examples of commercially available products of the acrylic resin dispersant include BYK-187, BYK-190, BYK-191, BYK-194N, and BYK-199 (manufactured by BYK Japan KK), and Aron A-210, A6114, AS-1100, AS-1800, A-30SL, A-7250, and CL-2 manufactured by TOAGOSEI CO., LTD.).

Furthermore, examples of commercially available products of the urethane resin dispersant include BYK-182, BYK-183, BYK-184, and BYK-185 (manufactured by BYK Japan KK), TEGO Dispers 710 (manufactured by Evonik Tego Chemie GmbH), and Borchi (registered trademark) Gen 1350 (manufactured by OMG Borchers GmbH).

The resin dispersant may be used alone or in combination of two or more thereof. The total content of the dispersant is preferably 0.1 parts by mass or more and 30 parts by mass or less, more preferably 0.5 parts by mass or more and 25 parts by mass or less, further more preferably 1 part by mass or more and 20 parts by mass or less, and still further more preferably 1.5 parts by mass or more and 15 parts by mass or less with respect to 50 parts by mass of the pigment. When the content of the dispersant is 0.1 parts by mass or more with respect to 50 parts by mass of the pigment, the dispersion stability of the pigment can be further enhanced. In addition, when the content of the dispersant is 30 parts by mass or less with respect to 50 parts by mass of the pigment, the viscosity of the obtained dispersion can be suppressed to be small.

As the resin dispersant, preferably, a resin-dispersed pigment in which a resin is adsorbed on surfaces of pigment particles to disperse the pigment particles is used. Examples of such a resin dispersant include an anionic resin. The acid value of the resin dispersant is, for example, 300 mg KOH/g or less, preferably 250 mg KOH/g or less, more preferably 200 mg KOH/g or less, still more preferably 180 mg KOH/g or less, and particularly preferably 150 mg KOH/g or less. When the acid value of the resin dispersant is equal to or less than the above ranges, the reactivity with a calcium salt of the ink tends to decrease, and the effects on clogging recoverability and ejection stability tend to be further improved.

In particular, when the first ink contains the dispersant resin for dispersing the azo-based pigment, and the acid value of the dispersant resin is 200 mg KOH/g or less, color developability of the first ink can be further improved.

On the other hand, the lower limit of the acid value of the resin dispersant is preferably 30 mg KOH/g or more, and more preferably 50 mg KOH/g. The lower limit of the acid value is more preferably is 100 mg KOH/g. Further, the acid value is preferably 150 mg KOH/g or more. When the acid value of the resin dispersant is within the above ranges, color developability is more excellent. In addition, from the viewpoint of excellent suppression of phase separation of the acetylene glycol-based surfactant described later, the above range or more is preferable.

The acid value of the resin dispersant can be adjusted by, for example, the ratio of the input amount of a monomer having an acidic group when used in synthesis of the resin. Examples of the acidic group include a carboxy group.

As the resin of the resin dispersant, for example, an acrylic resin, a urethane-based resin, a maleic resin, or the like can be used, and an acrylic resin or a maleic resin is preferable.

When the resin dispersant is used, the mass ratio of the amount of the resin dispersant used to the amount of the pigment used (resin dispersant/pigment) is preferably 1 or more and 20 or less, 2 or more and 10 or less, or 3 or more and 8 or less. When the mass ratio of the amount of the resin dispersant used to the amount of the pigment used is within the above ranges, the effects of the present disclosure on clogging recoverability, color developability, and ejection stability tend to be further improved.

The pigment may be a self-dispersible pigment. The self-dispersible pigment is obtained by introducing a hydrophilic functional group onto a surface of the pigment using a chemical reaction to impart dispersion stability to the pigment, and disperse the pigment. Examples of the hydrophilic functional group include a carboxy group, a phosphorus-containing group such as a phosphonic acid group, and an acidic group such as a sulfo group.

In a case where the pigment is the self-dispersible pigment, the thickening ratio of the ink may be adjusted by adjusting the introduction amount of the hydrophilic functional group introduced onto the pigment surface. Even when the thickening ratio of the ink is less than 2, the resin-dispersed pigment is preferable in the point that the dispersion stability of the pigment is easily obtained.

### Fixing Resin

The first ink may contain a fixing resin. The fixing resin is a resin that is not the resin dispersant, is not attached or adsorbed to the pigment, and is a resin that is dispersed or dissolved as a single resin in the solvent component of the ink.

The fixing resin can further improve, for example, adhesiveness of an image formed with the first ink deposited onto the recording medium. In addition, by containing the fixing resin, transfer after printing is easily suppressed. When the fixing resin has reactivity with calcium, the reactivity of the ink with calcium is also affected. In the case of an ink having low reactivity with calcium, a resin having low reactivity is preferable. The reactivity of the ink can be adjusted by adjusting the reactivity of the resin together with the pigment.

Examples of the fixing resin include fixing resins including a urethane-based resin, an acrylic resin (including a styrene-acrylic resin), a fluorene-based resin, a polyolefin-based resin, a rosin-modified resin, a terpene-based resin, a polyester-based resin, a polyamide-based resin, an epoxy-based resin, a vinyl chloride resin, a vinyl chloride-vinyl acetate copolymer, or an ethylene-vinyl acetate resin. Among these, a urethane-based resin, an acrylic resin, a polyolefin-based resin, and a polyester-based resin are preferable.

Examples of the fixing resin include resin particles and a water-soluble resin. The resin particles are often handled in the form of an emulsion, but may also have properties of powder. The water-soluble resin is a resin that is soluble in water, and is dissolved in a solvent component containing water as a main component in the ink. The fixing resin may be used alone or in combination of two or more thereof.

The urethane-based resin is a general term for a resin having a urethane bond. As the urethane-based resin, a polyether-type urethane resin including, in addition to a urethane bond, an ether bond in the main chain, a polyester-type urethane resin including, in addition to a urethane bond, an ester bond in the main chain, a polycarbonate-type urethane resin including a carbonate bond in the main chain, and the like may be used. In addition, commercially available products may be used as the urethane-based resin. For example, commercially available products such as SUPERFLEX 420, 460, 460s, 840, and E-4000 (trade names, manufactured by DKS Co., Ltd.), RESAMINE D-1060, D-2020, D-4080, D-4200, D-6300, and D-6455 (trade names, manufactured by Dainichiseika Color & Chemicals Mfg. Co., Ltd.), Takelac WS-6021 and W-512-A-6 (trade names, manufactured by MITSUI CHEMICALS POLYURETHANES, INC.), Sancure 2710 (trade name, manufactured by The Lubrizol Corporation), and PERMARIN UA-150 (trade name, manufactured by Sanyo Chemical Industries, Ltd.) may be used.

The acrylic resin is a general term for polymers obtained by polymerizing at least an acrylic monomer such as (meth)acrylic acid or (meth)acrylic acid ester as one component, and examples thereof include a resin obtained from an acrylic monomer, and a copolymer of an acrylic monomer and a monomer other than the acrylic monomer. Examples thereof include an acrylic-vinyl-based resin which is a copolymer of an acrylic monomer and a vinyl-based monomer. In addition, examples of the vinyl-based monomer include styrene.

As the acrylic monomer, acrylamide, acrylonitrile, and the like can also be used. As a resin emulsion using the acrylic resin as a raw material, commercially available products may be used, and for example, the resin emulsion selected from FK-854 (trade name, manufactured by CHUORIKA KOGYO Co., Ltd.), Mowinyl 952B and 718A (trade names, manufactured by The Nippon Synthetic Chemical Industry Co., Ltd.), Nipol LX852 and LX874 (trade names, manufactured by Zeon Corporation), and the like may be used.

Incidentally, in the present specification, the acrylic resin may be a styrene-acrylic resin described later. In addition, in the present specification, the term “(meth)acrylic” means at least one of acrylic and methacrylic.

The styrene-acrylic resin is a copolymer obtained from a styrene monomer and a (meth)acrylic monomer, and examples thereof include a styrene-acrylic acid copolymer, a styrene-methacrylic acid copolymer, a styrene-methacrylic acid-acrylate copolymer, a styrene-α-methylstyrene-acrylic acid copolymer, and a styrene-α-methylstyrene-acrylic acid-acrylate copolymer. As the styrene-acrylic resin, commercially available products may be used, and for example, JONCRYL 62J, 7100, 390, 678, 711, 511, 7001, 632, 741, 450, 840, 74J, HRC-1645J, 734, 852, 7600, 775, 537J, 1535, PDX-7630A, 352J, 352D, PDX-7145, 538J, 7640, 7641, 631, 790, 780, and 7610 (trade names, manufactured by BASF SE), Mowinyl 966A and 975 N (trade names, manufactured by The Nippon Synthetic Chemical Industry Co., Ltd.), VINYBLAN 2586 (trade name, manufactured by Nissin Chemical Industry Co., Ltd.) and the like may be used.

The polyolefin-based resin has an olefin such as ethylene, propylene, or butylene in the structural skeleton, and a known resin can be appropriately selected and used. As the olefin resin, a commercially available product can be used, and for example, ARROWBASE CB-1200 and CD-1200 (trade names, manufactured by UNITIKA LTD.), and the like may be used.

Further, the polymer particles may be supplied in the form of an emulsion, as examples of commercially available products of such resin emulsions, Microgel E-1002 and E-5002 (trade names, manufactured by Nippon Paint Co., Ltd.), styrene-acrylic resin emulsion), VONCOAT 4001 (trade name, manufactured by DIC Corporation, acrylic resin emulsion), VONCOAT 5454 (trade name, manufactured by DIC Corporation, styrene-acrylic resin emulsion), POLYSOL AM-710, AM-920, AM-2300, AP-4735, AT-860, PSASE-4210E (acrylic resin emulsion), POLYSOL AP-7020 (styrene-acrylic resin emulsion), POLYSOL SH-502 (vinyl acetate resin emulsion), POLYSOL AD-13, AD-2, AD-10, AD-96, AD-17, AD-70 (ethylene-vinyl acetate resin emulsion), POLYSOL PSASE-6010 (ethylene-vinyl acetate resin emulsion) (trade name, manufactured by Showa Denko K.K.), POLYSOL SAE1014 (trade name, styrene-acrylic resin emulsion, manufactured by Zeon Corporation), Saibinol SK-200 (trade name, acrylic resin emulsion, manufactured by SAIDEN CHEMICAL INDUSTRY CO., LTD.), AE-120A (trade name, manufactured by JSR Corporation, acrylic resin emulsion), AE373D (trade name, manufactured by Emulsion Technology Co., Ltd., carboxy-modified styrene-acrylic resin emulsion), SEIKADYNE 1900W (trade name, manufactured by Dainichiseika Color & Chemicals Mfg. Co., Ltd., ethylene-vinyl acetate resin emulsion), VINYBLAN 2682 (acrylic resin emulsion), VINYBLAN 2886 (vinyl acetate acrylic resin emulsion), VINYBLAN 5202 (acetic acid acrylic resin emulsion) (trade name, manufactured by Nissin Chemical Industry Co., Ltd.), ELITEL KA-5071S, KT-8803, KT-9204, KT-8701, KT-8904, KT-0507 (trade names, manufactured by UNITIKA LTD., polyester resin emulsion), Hytec SN-2002 (trade name, manufactured by TOHO Chemical Industry Co., Ltd., polyester resin emulsion), TAKELAC W-6020, W-635, W-6061, W-605, W-635, W-6021 (trade name, manufactured by Mitsui Chemicals Polyurethanes, Inc., urethane-based resin emulsion), SUPERFLEX 420, 870, 800, 150, 420, 460, 470, 610, 700 (trade name, manufactured by DKS Co., Ltd., urethane-based resin emulsion), PERMARIN UA-150 (manufactured by Sanyo Chemical Industries, Ltd., urethane-based resin emulsion), Sancure 2710 (manufactured by The Lubrizol Corporation, Japan, urethane-based resin emulsion), NeoRez R-9660, R-9637, r-940 (manufactured by Kusumoto Chemicals, Ltd., urethane-based resin emulsion), ADEKA BONTIGHTER HUX-380, 290K (manufactured by ADEKA CORPORATION, urethane-based resin emulsion), Mowinyl 966A, Mowinyl 7320 (manufactured by the Nippon Synthetic Chemical Industry Co., Ltd.), JONCRYL 7100, 390, 711, 511, 7001, 632, 741, 450, 840, 74J, HRC-1645J, 734, 852, 7600, 775, 537J, 1535, PDX-7630A, 352J, 352D, PDX-7145, 538J, 7640, 7641, 631, 790, 780, 7610 (which are manufactured by BASF SE), NK Binder R-5HN (manufactured by SHIN-NAKAMURA CHEMICAL Co., Ltd.), HYDRAN WLS-210 (non-crosslinkable polyurethane: manufactured by DIC Corporation), JONCRYL 7610 (manufactured by BASF SE) or the like may be selected and used.

The volume-average particle diameter of the resin particles is preferably 10 nm or more and 300 nm or less, more preferably 30 nm or more and 300 nm or less, still more preferably 30 nm or more and 250 nm or less, and particularly preferably 40 nm or more and 220 nm or less. The volume-average particle diameter can be measured by the method described above.

In a case where the fixing resin is contained or not contained in the first ink, the content thereof is preferably 10% by mass or less in terms of solid content with respect to the total mass of the first ink.

The content is more preferably 0.01% by mass or more and 10% by mass or less, preferably 0.1% by mass or more and 5% by mass or less, more preferably 0.1% by mass or more and 1% by mass or less, and still more preferably 0.1% by mass or more and 0.5% by mass or less. In a case where the fixing resin is a reactive resin, the content is preferably small from the viewpoint of reducing the reactivity of the ink, whereas the content is preferably large from the viewpoint of suppressing transfer.

### Additive

The first ink may contain a urea, an amine, a saccharide, or the like as an additive. Examples of the urea include urea, ethyleneurea, tetramethylurea, thiourea, 1,3-dimethyl-2-imidazolidinone, and a betaine (such as trimethylglycine, triethylglycine, tripropylglycine, triisopropylglycine, N,N,N-trimethylalanine, N,N,N-triethylalanine, N,N,N-triisopropylalanine, N,N,N-trimethylmethylalanine, carnitine, and acetylcarnitine).

Examples of the amine include diethanolamine, triethanolamine, and triisopropanolamine. The urea and amine may function as a pH adjuster or an alkali agent.

Examples of the saccharide include glucose, mannose, fructose, ribose, xylose, arabinose, galactose, aldonic acid, glucitol (sorbitol), maltose, cellobiose, lactose, sucrose, trehalose, and maltotriose.

Further, the first ink may contain a component such as a preservative/fungicide, a rust inhibitor, a chelating agent, a viscosity modifier, an antioxidant, a fungicide, or wax, if necessary. In addition, the first ink according to the present embodiment may contain a coloring material other than the azo-based pigment, if necessary, within a range not inhibiting the effect described later.

### 1. 1. 2. Second Ink

The second ink contains a pigment and is a chromatic ink other than the red-based ink. The second ink is an aqueous ink.

### (1) Pigment

As the pigment, for example, a color pigment such as cyan, yellow, or black pigment is preferable. The pigment may be a white pigment or a special color pigment. The pigment is excellent in storage stability such as light resistance, weather resistance, and gas resistance, and is preferably an organic pigment from that viewpoint.

Specific examples of the pigment include azo pigments such as an insoluble azo pigment, a condensed azo pigment, an azo lake, and a chelated azo pigment, polycyclic pigments such as a phthalocyanine pigment, a perylene and perinone pigments, an anthraquinone pigment, a quinacridone pigment, a dioxane pigment, a thioindigo pigment, an isoindolinone pigment, and a quinophthalone pigment, a dye chelate, a dye lake, a nitro pigment, a nitroso pigment, aniline black, a daylight fluorescent pigment, and carbon black. These pigments may be used alone or in combination of two or more thereof. In addition, as a non-white coloring material, a photoluminescent pigment may be used.

Specific examples of the pigment are not particularly limited, but include the following, for example.

Examples of a black pigment include No. 2300, No. 900, MCF 88, No. 33, No. 40, No. 45, No. 52, MA7, MA8, MA100, and No. 2200B (which are all manufactured by Mitsubishi Chemical Corporation), Raven 5750, Raven 5250, Raven 5000, Raven 3500, Raven 1255, and Raven 700 (which are all manufactured by Columbia Carbon corporation), Regal 400R, Regal 330R, Regal 660R, Mogul L, Monarch 700, Monarch 800, Monarch 880, Monarch 900, Monarch 1000, Monarch 1100, Monarch 1300, and Monarch 1400 (manufactured by CABOT JAPAN K.K.), Color Black FW1, Color Black FW2, Color Black FW2V, Color Black FW18, Color Black FW200, Color Black S150, Color Black S160, Color Black S170, Printex 35, Printex U, Printex V, Printex 140U, Special Black 6, Special Black 5, Special Black 4A, and Special Black 4 (which are all manufactured by Degussa AG).

Examples of a yellow pigment include C.I. Pigment Yellow 1, 2, 3, 4, 5, 6, 7, 10, 11, 12, 13, 14, 16, 17, 24, 34, 35, 37, 53, 55, 65, 73, 74, 75, 81, 83, 93, 94, 95, 97, 98, 99, 108, 109, 110, 113, 114, 117, 120, 124, 128, 129, 133, 138, 139, 147, 151, 153, 154, 167, 172, and 180.

Examples of a cyan pigment include C.I. Pigment Blue 1, 2, 3, 15, 15:1, 15:2, 15:3, 15:34, 15:4, 16, 18, 22, 25, 60, 65, and 66, and C.I. Bat blue 4 and 60.

In addition, pigments other than the magenta, cyan, and yellow pigments are not particularly limited, and examples thereof include C.I. Pigment Green 7 and 10, C.I. Pigment Brown 3, 5, 25, and 26, and C.I. Pigment Orange 1, 2, 5, 7, 13, 14, 15, 16, 24, 34, 36, 38, 40, 43, and 63.

A pearl pigment is not particularly limited, and examples thereof include pigments having pearlescent or interference luster, such as titanium dioxide-coated mica, fish scale foil, and bismuth oxychloride.

A metallic pigment is not particularly limited, and examples thereof include particles formed of elemental metals, such as aluminum, silver, gold, platinum, nickel, chromium, tin, zinc, indium, titanium, and copper, and alloys thereof.

It is preferable that the pigment can be stably dispersed or dissolved in a dispersion medium, and the pigment may be dispersed using a dispersant if necessary. Examples of the dispersant can include the same dispersants as those used for improving the dispersibility of the pigment in the first ink described above.

The pigment may be dispersed using a dispersant. The dispersant is preferably a dispersant resin. The acid value of the dispersant resin of the pigment may be the same as the acid value of the dispersant resin of the white coloring material described above.

The content of the pigment is preferably 0.3% by mass or more and 20% by mass or less and more preferably 0.5% by mass or more and 15% by mass or less with respect to the total mass of the second ink. Further, the content is preferably 1% by mass or more and 10% by mass or less, and more preferably 2% by mass or more and 7% by mass or less.

The content of the pigment in the second ink is preferably smaller than the content of the pigment in the first ink. The content is more preferably 0.5% by mass or more. By doing so, it is possible to suppress decrease in redispersibility, ejection stability, clogging recoverability, and the like of the second ink.

In particular, in a yellow ink using a yellow pigment, even when the content of the pigment is increased, visibility of the color does not tend to improve in proportion to the increase. Therefore, it is less necessary to set the content of the pigment to be equal to or greater than the content of the pigment of the first ink.

### (2) Other Components

The second ink contains water. Water is the same as that described for the first ink described above. The second ink may contain an organic solvent, a lactam, a surfactant, a resin, an additive, and the like. These components are the same as those described for the first ink described above. The components of the second ink other than the pigment may be the same as those of the first ink.

### 1. 1. 3. Thickening Ratio

At least one of the first ink and the second ink has a thickening ratio of less than 2.0 when the ink is mixed with an aqueous calcium propionate solution having a Ca concentration of 0.3 mol/L at a mass ratio of 10:1 (ink composition:aqueous calcium propionate solution).

The thickening ratio is defined as follows.

The ink and an aqueous calcium propionate solution (Ca concentration: 0.3 mol/L) are mixed at a ratio of 10:1 (ink:aqueous calcium propionate solution), and the mixture is allowed to stand at 60° C. for 24 hours. In this way, each ink is mixed with the aqueous calcium propionate solution to form a mixture, and the mixture is allowed to stand as described above.

In this way, the components of the ink and calcium propionate are sufficiently reacted.

The viscosities of the ink in the initial state (before mixing) and the ink after standing (mixture) are measured. The measurement is performed at 25° C., and the sample is stirred well before the measurement. The viscosity can be measured using, for example, a rotatory viscometer.

The viscosity η1 of the ink after standing and the viscosity η0 of the ink in the initial state are calculated as the thickening ratio according to the following formula.

$$Thickening ratio ( fold ) = ink viscosity after standing η 1 / initial ink viscosity η 0$$

The thickening ratio of at least one of the first ink and the second ink is less than 2.0. Furthermore, the thickening ratio of the ink is more preferably less than 1.8, and even more preferably less than 1.6. The thickening ratio is more preferably less than 1.5. As a result, color difference reduction is more excellent. Furthermore, the ink is excellent in redispersibility and the like.

On the other hand, the lower limit of the thickening ratio of the ink is not particularly limited, but is preferably 1.0 or more, and more preferably 1.2 or more. The thickening ratio is more preferably 1.5 or more. This is preferable because color developability of the ink is more excellent.

The thickening ratio of the first ink is preferably less than 2.0 from the viewpoint of excellent reduction in color difference of a red-based image formed using the first ink.

On the other hand, as long as the thickening ratio of at least one of the first ink and the second ink is less than 2.0, the first ink or the second ink the thickening ratio of which is not less than 2.0 may be present. That is, the other of the first ink and the second ink may have a thickening ratio of 2.0 or more. Even in this case, color difference streaks can be sufficiently reduced. Further, color developability of the other ink is excellent, which is preferable.

### 1. 1. 4. Combination of Colors of First Ink and Second Ink

The first ink may be a magenta ink, and the second ink may be a yellow ink or a cyan ink. According to this configuration, as an ink using an azo pigment and having low reactivity with calcium is used as the magenta ink, the second ink can be an ink having high reactivity with calcium, and the degree of freedom of design can be increased. Further, for example, by using an ink having high reactivity with calcium as the yellow ink, the visibility of yellow can be improved, which is more preferable. By using the yellow ink having high reactivity with calcium and the magenta ink having low reactivity with calcium in an image of a warm-color-based color in which color difference streaks are likely to be conspicuous, an image having high visibility and reduced color difference streaks can be recorded in an image using the yellow ink and the magenta ink. The present embodiment is particularly useful in recording of a secondary color using a yellow ink and a magenta ink.

The reactivity of the ink with calcium ions can be adjusted by reactivity of the components contained in the ink with calcium ions. For example, in a case of the resin-dispersed pigment, the reactivity can be lowered by lowering the acid value of the pigment dispersant resin. In a case of the self-dispersible pigment, the reactivity can be lowered by reducing the introduction amount of the acidic group to be introduced into the pigment.

When the second ink is a cyan ink, the reactivity is also preferably high. The cyan ink is often used for generating a secondary color (blue) with the magenta ink (first ink). However, since the reactivity of the magenta ink is low, color difference streaks of blue can be further reduced.

Further, the problem of color difference streaks tends to be more significant between inks used for generating a secondary color (between two inks having adjacent hue angles). If the reactivity of the magenta ink is low, it is possible to increase the reactivity of the yellow and cyan inks in printing of a secondary color (red-based or blue-based color) with the yellow or cyan ink. In addition, particularly in a red-based image in which high color developability is useful, the color difference can be reduced, which is preferable.

### 1. 2. Recording Medium

The recording medium is not particularly limited, and examples thereof include an absorptive recording medium, a low-absorptive recording medium, and a non-absorptive recording medium. Among these, an absorptive recording medium and a low-absorptive recording medium are preferable, and an absorptive recording medium is more preferable. The present disclosure is particularly useful because the higher the absorbency, the more easily the difference in permeation due to the difference in the inter-nozzle distance occurs. That is, when the absorptive recording medium with which the pigment is less likely to remain on the surface is used, the effect of the recording method of the present embodiment of improving color developability on the surface in addition to the reduction of color difference streaks becomes more remarkable.

Here, the “low-absorptive recording medium” or “non-absorptive recording medium” refers to a recording medium in which the water absorption amount from the start of contact to 30 msec in the Bristow's method is 10 mL/m² or less. The Bristow's method is the most popular method for measuring a liquid absorption amount in a short time and is also adopted by Japan Technical Association of the Pulp and Paper Industry (JAPAN TAPPI). Details of the test method are described in the standard No. 51 “Method for determining the liquid absorbability of paper and board (Bristow's method)” in “JAPAN TAPPI Paper Pulp Test Method 2000 Edition.”

The low-absorptive recording medium refers to a recording medium having the above-described water absorption amount of 5 mL/m² or more and 10 mL/m² or less. On the other hand, the absorptive recording medium refers to a recording medium having the above-described water absorption amount of more than 10 mL/m².

The absorptive recording medium is not particularly limited, and examples thereof include plain paper such as electrophotographic paper having high permeability of the ink composition, ink jet paper (ink jet dedicated paper including an ink absorbing layer formed from silica particles or alumina particles, or an ink absorbing layer formed from a hydrophilic polymer such as polyvinyl alcohol (PVA) or polyvinylpyrrolidone (PVP)), and the like. Fabric is also an example of the absorptive recording medium.

The low-absorptive recording medium is not particularly limited, and examples thereof include coated paper provided with a coating layer for receiving an oil-based ink on the surface. The coated paper is not particularly limited, and examples thereof include printing text paper such as art paper, coated paper, and matte paper.

The non-absorbent recording medium is not particularly limited, and examples thereof include films and plates of plastic such as polyvinyl chloride, polyethylene, polypropylene, Polyethylene terephthalate (PET), polycarbonate, polystyrene, and polyurethane; plates of metal such as iron, silver, copper, and aluminum; metal plates produced through vapor deposition of such various kinds of metal, plastic films, and plates of alloy such as stainless steel and brass; and recording media in which a film of plastic such as polyvinyl chloride, polyethylene, polypropylene, polyethylene terephthalate (PET), polycarbonate, polystyrene, or polyurethane is adhered to (coats) a paper base material.

### 1. 3. Transporting Step

The recording method of the present embodiment includes a transporting step. In the transporting step, the recording medium is transported in a predetermined direction within the recording apparatus. More specifically, the recording medium is transported from a paper feeder to a paper discharger of the recording apparatus using a transporting roller and a transporting belt provided within the recording apparatus. The ink ejected from the ink jet head is deposited onto the recording medium during this transporting process to form a recorded material. The transportation may be performed continuously or intermittently.

### 1. 4. Ink Deposition Step

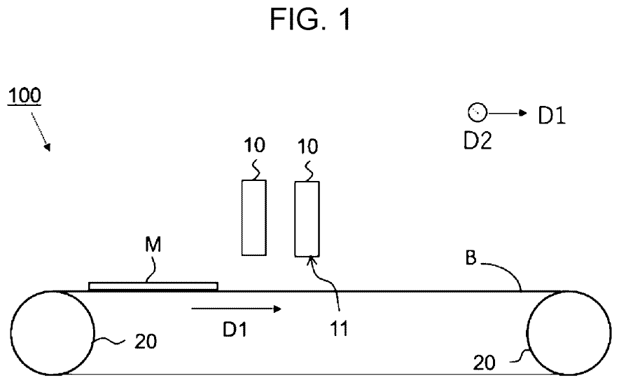

The ejection step is a step of ejecting the first ink and the second ink from the line head having a length equal to or greater than the recording width of the recording medium and depositing the first ink and the second ink onto the recording medium. FIG. 1 illustrates a schematic cross-sectional view of a recording apparatus capable of being used in the recording method of the present disclosure.

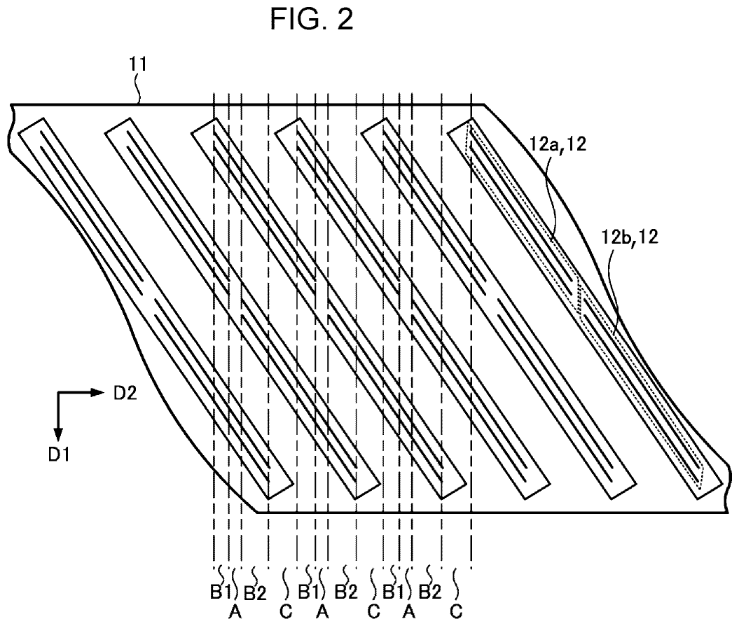

A line head 10 has a length equal to or greater than the recording width of the recording medium, and is a unit that ejects the ink composition to deposit the ink composition onto a recording medium M. The ink jet head 10 includes a plurality of unit heads 12 (see FIG. 2) in the direction of the recording width of the recording medium on a nozzle surface 11 facing the recording medium M. The unit head 12 has a plurality of nozzles for ejecting the ink composition. The plurality of nozzles included in the unit head 12 is arranged at positions different from each other in the recording width direction and is also referred to as a “nozzle group.”

The nozzles of the nozzle group may be arranged side by side, and may be arranged in a row, for example. A group of nozzles arranged in a row is also referred to as a “nozzle row.”

The recording medium M is transported in the transport direction while being supported by a belt B. The belt B is moved in the transport direction D1 by a belt roller 20. The recording apparatus may include a paper feed tray, a paper discharge tray, and the like (not shown).

The unit head 12 has such a nozzle group, and the structure or the like is not limited except for having the nozzle group. The nozzle group is, for example, a nozzle row, but may be a nozzle group. A portion of the line head 10 in which one nozzle group exists is one unit head 12. It can also be said that the nozzle group is the unit head 12.

In the present embodiment, the line head 10 has a portion in which the inter-nozzle distance between the first nozzles that eject the first ink and the second nozzles that eject the second ink in the scanning direction is different in the recording width direction. As a result, a color difference is caused, making the present disclosure particularly useful.

In a line method using a line head, an ink jet head having a width equal to or more than the recording width of the recording medium is fixed to the recording apparatus, for example. An image is then recorded on the recording medium by moving the recording medium along the scanning direction (longitudinal direction of the recording medium, transport direction), and performing scanning to eject ink droplets from the nozzles of the ink jet head in conjunction with this movement.

Alternatively, the recording medium is fixed to the recording apparatus. An image is then recorded on the recording medium by moving the ink jet head having a width equal to or greater than the recording width of the recording medium along the scanning direction, and performing scanning to eject ink droplets from the nozzles of the ink jet head in conjunction with this movement. The scanning direction is the direction of scanning.

Since recording can be performed by one-pass scanning of the line head and the recording medium in such a line method using the line head, the printing speed can be improved.

FIG. 2 shows an example of a nozzle surface of an ink jet head having portions with different inter-nozzle distances. In the present embodiment, a unit head including the first nozzles that eject the first ink is referred to as a first unit head 12a, a unit head including the second nozzles that eject the second ink is referred to as a second unit head 12b, and the unit heads are each simply referred to as a unit head 12 when the unit heads are not distinguished from each other.

In addition, an aspect in which the first unit head 12a ejects the first ink and the second unit head 12b ejects the second ink will be shown as an example below, but the aspect is merely an example. That is, the present disclosure may include an aspect in which one unit head includes a nozzle that ejects the first ink and a nozzle that ejects the second ink without distinction between the first unit head and the second unit head. More specifically, in a case where the unit head includes a plurality of nozzle rows, each nozzle row may be capable of ejecting a different ink composition.

For example, the first unit head 12a and the second unit head 12b may not be separate members, but may be an integrated member. Further, a plurality of first unit heads 12a arranged side by side in the width direction and a plurality of second unit heads 12b arranged side by side in the width direction may not be separate members but may be an integrated member. A plurality of unit heads 12 constituting the line head may not be separate members, but may be an integrated member.

Even in this case, a portion in which one nozzle row ejecting the first ink is present is the first unit head 12a, and a portion in which one nozzle row ejecting the second ink is present is the second unit head 12b. That is, the unit head 12 is also a nozzle row.

In addition, one first unit head 12a has two nozzle rows in the scanning direction in the drawing, but the number of nozzle rows may be one or two or more, and at least one of the nozzle rows may be a nozzle row ejecting the first ink. The same applies to the second unit head 12b.

In the example of FIG. 2, the first unit head 12a and the second unit head 12b are arranged in the longitudinal direction to form one unit 12, and the unit 12 is arranged in the width direction D2 such that the longitudinal direction of the unit 12 obliquely intersects the width direction D2 of the line head. In FIG. 2, there is a gap between the obliquely arranged adjacent units 12, but instead of this configuration, the adjacent units 12 may be arranged so as to be adjacent without the gap.

In the example of FIG. 2, a first nozzle group including a plurality of first nozzles ejecting the first ink and a second nozzle group including a plurality of second nozzles ejecting the second ink are arranged obliquely with respect to the direction of the recording width. As a result, it is possible to adjust the apparent nozzle density in the width direction of the entire line head, and the number of unit heads necessary for configuring a line head having a predetermined distance in the width direction.

When a case of oblique arrangement with respect to the width direction D2 as in the example of FIG. 2 is compared with a case parallel arrangement with respect to the width direction D2, even if the first unit head 12a and the second unit head 12b having the same nozzle density are used, the nozzle density in the width direction of the line head as a whole is higher in the case of oblique arrangement with respect to the width direction D2 as in the example of FIG. 2. That is, the nozzle density is improved in the oblique arrangement with respect to the width direction D2. Therefore, the recording resolution is increased and the image quality is excellent, which is preferable. In this case, since the distance between the nozzles in the scanning direction is further increased, the present disclosure is particularly useful.

In the example shown in FIG. 2, in the scanning direction, there may be a portion in which the distance between the first unit head 12a and the second unit head 12b varies, or a portion in which the first unit head 12a or the second unit head 12b overlaps. As shown in FIG. 2, names and reference numerals are assigned to these portions in the present specification. That is, in the example of FIG. 2, there are a straddling portion A, an overlapping portion B1, an overlapping portion B2, and a normal portion C.

In the normal section C, the first unit head 12a and the second unit head 12b are operated to perform scanning with respect to the recording medium once each. Further, in the overlapping portion B1, the first unit head 12a is operated to perform scanning twice and the second unit head 12b is operated to perform scanning once with respect to the recording medium. In addition, in the overlapping portion B2, the first unit head 12a is operated to perform scanning once and the second unit head 12b is operated to perform scanning twice with respect to the recording medium. In the straddling portion A, the first unit head 12A and the second unit head 12b are operated to perform scanning with respect to the recording medium once each.

When the time difference between landing of the first ink and landing of the second ink on the recording medium in the normal portion C is set as a reference, the time difference in the straddling portion A is about twice the reference. The time difference between landing of the first ink and landing of the second ink on the recording medium is a time difference between landing of the first ink and landing of the second ink on a certain point of the recording medium. That is, the time difference is a time difference between landing of the first ink and landing of the second ink at the same point on the recording medium.

On the other hand, the time difference can be changed by selecting the unit heads to be used in the overlapping portion B1 and the overlapping portion B2, and the time difference is the same as or about twice the time difference in the normal portion C. Even when the time difference in the straddling portion A is set as a reference, the time differences of the overlapping portion B1 and the overlapping portion B2 can be changed depending on the selection of the unit heads to be used, and the time difference is the same as or about ½ times the time difference in the straddling portion A.

However, in the example of FIG. 2, the landing time difference is different between the straddling portion A and the normal portion C. In addition, even when the selection of the unit heads to be used is adjusted, the overlapping portion B1 and the overlapping portion B2 have different landing time differences with respect to any one of the straddling portion A and the normal portion C. As a result, it is difficult to land the first ink and the second ink with the same landing time difference over the entire region of the line head in the width direction D2. That is, a portion in which the landing time difference varies between portions of the line head in the direction D2 intersecting the recording-medium transport direction D1 is generated.

In addition, when a landing time difference is expressed by the inter-nozzle distance, in the example of FIG. 2, the first nozzles ejecting the first ink and the second nozzles ejecting the second ink are arranged such that the inter-nozzle distances of the first nozzles ejecting the first ink and the second nozzles ejecting the second ink are different in recording.

The difference in the inter-nozzle distance and the landing time difference can be changed by setting the inclination and the density of the nozzle group with respect to the direction of the recording width and changing the transporting speed of the recording medium. When the landing time difference is 1.1 times or more in a long portion with reference to that in a short portion, the effect of the recording method of the present embodiment can be sufficiently obtained, which is preferable. Further, the effect is remarkable when the landing time difference is 1.2 times or more, preferably 1.5 times or more, more preferably 2 times or more, and still more preferably 2.5 times or more. The landing time difference is preferably 4 times or less, and more preferably 3 times or less.

In addition, as the scanning speed of the recording medium increases, the landing time difference between the first ink and the second ink decreases, and the color difference tends to be suppressed, but other problems such as landing position deviation may occur. Further, as the scanning speed of the recording medium decreases, the color difference unevenness is more likely to occur, and thus the present disclosure is more useful.

The nozzle density of the nozzle rows in the unit head 12 is preferably 50 npi. In addition, the nozzle density is preferably 1000 npi or less. Further, the nozzle density is preferably 100 to 800 npi, more preferably 200 to 600 npi, and still more preferably 300 to 500 npi.

In addition, the nozzle density in the width direction of the recording apparatus may be the same as the above ranges, which is preferable. The nozzle density in the width direction of the recording apparatus is an apparent nozzle density in the width direction when the head is arranged obliquely with respect to the width direction D2 as in the example of FIG. 2. In addition, the nozzle density is a nozzle density of a nozzle row ejecting one ink.

The ink jet head is not limited to the arrangement in which the head is arranged obliquely with respect to the width direction D2 as in the example of FIG. 2, and the head may be arranged in parallel with respect to the width direction D2, for example, as in the case of the FIG. 2A and FIG. 2B of JP-A-2023-135219. Even in this case, a portion in which the landing time difference between the first ink and the second ink varies between the portions of the line head in the direction D2 intersecting the recording-medium transport direction D1 is generated, and thus the present embodiment is required.

Examples of a method of ejecting the ink composition from the nozzles include a method of ejecting, from the nozzles, the composition filling a pressure generating chamber of the ink jet head by driving a pressure generating unit and a method of ejecting the composition by applying thermal energy. Such an ejection method is also referred to as an ink jet method. A method of applying pressure to the ink composition in the nozzles is not particularly limited, and examples thereof include a piezoelectric method of ejecting ink composition droplets using a piezoelectric element, and a thermal method of ejecting droplets by heating.

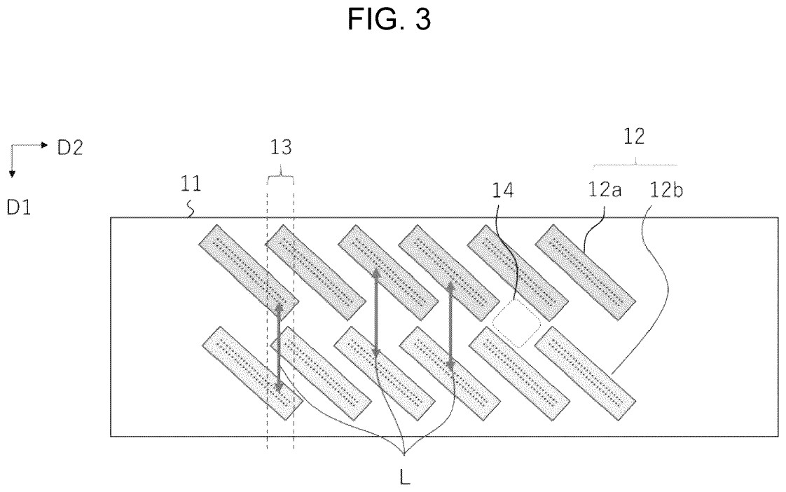

FIG. 3 shows an example of another ink jet head. In the example shown in FIG. 3, the length between the first unit head 12a and the second unit head 12b in the direction D1 is longer than that in the example shown in FIG. 2. Therefore, the straddling portion A shown in FIG. 2 does not exist. An overlapping portion 13 can make the length L in the direction D1 between the nozzles of the first unit head 12b and the nozzles of the second unit head 12b the same as that of the normal portion by adjusting the selection of the unit heads to be used.

Therefore, there is no portion in which the landing time difference between the first ink and the second ink varies in the recording width direction D2. However, in the example of FIG. 3, it is necessary to provide a gap 14 to a considerable extent in order not to have a portion in which the inter-nozzle distance varies. Therefore, miniaturization of the head cannot be achieved. In addition, as compared with the example of FIG. 2, there are many overlapping portions 13, resulting in significant waste of the head.

### 1. 5. Mode of Attachment

The recording method of the present embodiment is performed by a recording apparatus having the line head as exemplified above. That is, the recording method of the present embodiment is performed by using the line head having a portion in which a time difference between landing of the first ink and landing of the second ink on a certain point of the recording medium varies between portions of the line head in the direction intersecting the transport direction of the recording medium.

The deposition order of the first ink and the second ink can be arbitrarily set by appropriately selecting the nozzle group to be used. However, for example, the first ink may be deposited after the second ink is deposited. In this case, based on the example of FIG. 2 described above, the first unit head 12a ejects the second ink, and the second unit head 12b ejects the first ink.

In this way, the first ink (magenta) is deposited later. As a result, the latter first ink is more likely to be present on the upper side in the ink layer formed after deposition, and thus the color developability of red-based colors tends to be enhanced, which is more preferable in recording of a red-based image.

In addition, the line head may have a portion in which the inter-nozzle distance between the first nozzle and the second nozzle in the transport direction varies between portions in a direction intersecting the transport direction, and the portion in which the inter-nozzle distance varies may be a portion in which the landing time difference varies. Accordingly, even in a situation in which a color difference streak is more likely to occur, it is possible to reduce color difference streaks by using the line head having a portion in which the landing time difference between the first ink and the second ink varies.

### 1. 6. Operation and Effect

The recording medium such as plain paper contains a calcium salt therein. In a case where the ink is an ink having high reactivity with calcium ions, the ink deposited onto the recording medium reacts with calcium ions of the recording medium, and thus the solid content component of the ink is separated from water and forms an aggregate of the solid content. The aggregate of the solid content is solidified over time, and tends to overlap with the ink to make it difficult for the subsequently deposited ink to permeate. Further, due to the aggregate of the solid content reacted with calcium ions, the previously deposited ink itself is difficult to permeate.

On the other hand, in the case of an ink having low reactivity with calcium ions, the solid content of the deposited ink is not separated from water and remains in a dispersed state, and therefore the ink layer is less likely to be solidified even after a lapse of time from the deposition, and the ink subsequently deposited is likely to permeate the ink layer. In addition, the ink itself easily permeates.

In a case where the previously deposited ink is an ink having high reactivity with calcium ions, solidification of the previously deposited ink proceeds in a portion of an image having a large landing time difference between the previously deposited ink and the subsequently deposited ink, and the ink is less likely to permeate the portion. Further, in a case where the ink to be subsequently deposited is also an ink having high reactivity with calcium ions, the ink reacts and the solid content becomes an aggregate, which is difficult to permeate. In addition, the ink subsequently deposited is easily repelled by the previously deposited ink.

In this way, the previously deposited ink and the subsequently deposited ink are not mixed, and the boundary between the deposited inks becomes clear. On the other hand, in a portion of an image where the landing time difference is small, solidification of the previously deposited ink does not proceed, and therefore, the subsequently deposited ink easily permeates the previously deposited ink and is mixed with the previously deposited ink.

As a result, the appearance of the previously deposited ink and the subsequently deposited ink differs between a portion where the landing time difference with respect to the subsequently deposited ink is large and a portion where the landing time difference with respect to the subsequently deposited ink is small, and the color of the image varies. Thus, a color difference streak is generated.

In addition, it is considered that also in a portion in which solidification of the previously deposited ink proceeds and the ink hardly permeates, unreacted calcium remains in the solidified matter, and the subsequently deposited ink reacts with calcium on the previously deposited ink.

On the other hand, when the ink to be subsequently deposited is an ink having low reactivity with calcium ions, the subsequently deposited ink easily permeates. Therefore, the boundary of the inks is blurred and color difference streaks can be reduced. Alternatively, in a case where the ink to be previously deposited is an ink having low reactivity with calcium ions, the solid matter of the ink is less likely to be solidified, and the previously deposited easily permeates. Therefore, the boundary of the inks is blurred, and color difference streaks can be reduced.

Thus, when at least one of the inks is an ink having low reactivity with calcium ions, color difference streaks can be reduced. From the viewpoint of reducing color difference streaks, both inks may be inks having low reactivity with calcium ions.

### 2. RECORDING APPARATUS

The recording apparatus of the present embodiment is a recording apparatus which performs the recording method described above, and includes the ink composition described above and an ink jet head which ejects the ink composition described above to deposit the ink composition onto the recording medium transported in the transporting step.

The ink jet head is a line head having a length equal to or more than a recording region of the recording medium in a direction intersecting the transport direction, and in the line head, the plurality of first nozzles ejecting the first ink is arranged side by side in a direction intersecting the transport direction, and the plurality of second nozzles ejecting the second ink is arranged side by side in a direction intersecting the transport direction.

The recording apparatus of the present embodiment may further include a transport unit (transport mechanism) that transports the recording medium. The transport unit includes, for example, a transporting roller and a transporting belt provided in the recording apparatus.

According to the recording apparatus of the present embodiment, since at least one ink of the ink composition is an ink having low reactivity with calcium ions, color difference streaks can be reduced.

### 3. EXAMPLES AND COMPARATIVE EXAMPLES

The present disclosure will be specifically described with reference to Examples and the like below, but the present disclosure is not limited to these Examples. Hereinafter, “part” and “%” are based on mass unless otherwise specified. Evaluation is performed in an environment at a temperature of 25° C. and a relative humidity of 40.0% unless otherwise specified.

### 3. 1. Preparation of Ink Composition

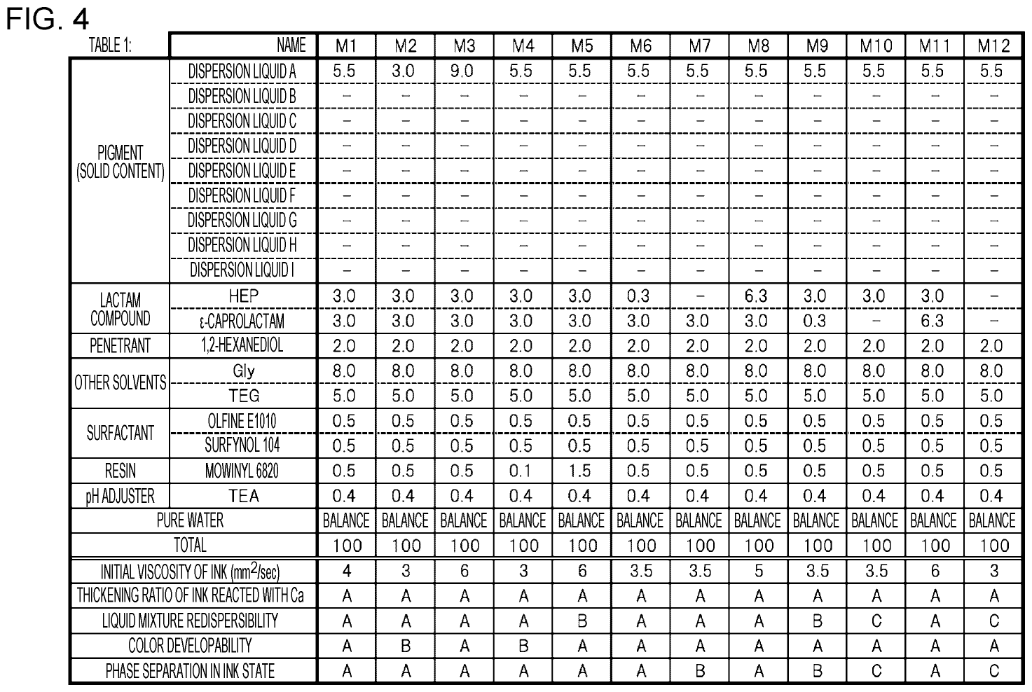

FIG. 3 and FIG. 4 show Tables 1 and 2 showing the compositions and evaluation results of the ink compositions of Examples and Comparative Examples.

An ink jet ink composition of each example was obtained by putting each component into a tank for a mixture so as to have the composition described in Table 1 and Table 2, mixing and stirring same, and further filtering same with a membrane filter. Numerical values of the respective components shown in each example in the tables represent mass % unless otherwise described. In addition, in the tables, the numerical values of the inorganic oxide particles, resin particles, and pigment dispersion liquid represent the solid contents of the inorganic oxide particles, resin particles, and pigment in terms of mass %, respectively. All of the obtained M inks are magenta inks, and all of the obtained Y inks are yellow inks.

The abbreviations used in Tables 1 and 2 and the details of the product components are as follows, and the number described on the right side of the abbreviation of each solvent indicates the SP value of the solvent.

### Pigment

Pigment dispersions A to F were prepared as follows.

Dispersion liquid A: A mixture was obtained by mixing and stirring 20% by mass of C.I. Pigments Red 150 (PR150), which is an azo pigment, 5% by mass of a resin dispersant (acid value: 150 mg KOH/g, molecular weight: 10,000), which is a sodium hydroxide neutralized product of a styrene-acrylic acid copolymer, and 75% by mass of pure water. The mixture was put into a wet sand mill filled with 0.3 mm zirconia beads and subjected to a dispersion treatment for 6 hours. Thereafter, the zirconia beads were removed by a separator, and the resultant was filtered through a cellulose acetate filter having a pore diameter of 3.0 μm to obtain a pigment dispersion liquid. The styrene-acrylic acid copolymer is a water-soluble polymer generally used as a dispersant for a pigment. The volume-average particle size D50 of the dispersion liquid A measured by a particle size distribution meter is each 100 nm. The acid value of the resin dispersant is low (reaction with calcium ions is hardly occur), thickening ratio=A. The thickening ratio will be described later.

Dispersion liquid B: A dispersion liquid B was obtained in the same manner as in the dispersion liquid A except that the acid value of the resin dispersant was changed to 260 mg KOH/g. The acid value of the resin dispersant is high (reaction with calcium ions is hardly occur), thickening ratio=C.

Dispersion liquid C: A dispersion liquid C was obtained in the same manner as in the dispersion liquid A except that the acid value of the resin dispersant was changed to 200 mg KOH/g. The acid value of the resin dispersant is medium (reaction with calcium ions is hardly occur), thickening ratio=B.

Dispersion liquid D: A dispersion liquid D was obtained in the same manner as in the dispersion liquid A except that C.I. Pigment Yellow 74 (PY74), which is a yellow azo pigment, was used instead of C.I. Pigment Red 150 (PR150). The acid value of the resin dispersant is low (reaction with calcium ions is hardly occur), thickening ratio=A.

Dispersion liquid E: A dispersion liquid E was obtained in the same manner as in the dispersion liquid D except that the acid value of the resin dispersant was changed to 260 mg KOH/g. The acid value of the resin dispersant is high (reaction with calcium ions is easily occur), thickening ratio=C.

Dispersion liquid F: A dispersion F was obtained in the same manner as in the dispersion liquid D except that the acid value of the resin dispersant was changed to 200 mg KOH/g. The acid value of the resin dispersant is medium (reaction with calcium ions is hardly occur), thickening ratio=B.

Dispersion liquid G: A dispersion liquid G was obtained in the same manner as in the dispersion liquid A except that C.I. Pigment Violet 19 (PV19), which is a quinacridone pigment, was used instead of C.I. Pigment Red 150 (PR150). The acid value of the resin dispersant is low (reaction with calcium ions is hardly occur), thickening ratio=A.

Dispersion liquid H: A dispersion H was obtained in the same manner as in the dispersion liquid G except that the acid value of the resin dispersant was changed to 260 mg KOH/g. The acid value of the resin dispersant is high (reaction with calcium ions is easily occur), thickening ratio=C.

Dispersion liquid I: A dispersion liquid I was obtained in the same manner as in the dispersion liquid A except that C.I. Pigment Red 17 (PR17), which is an azo pigment, was used instead of C.I. Pigment Red 150 (PR150). The acid value of the resin dispersant is low (reaction with calcium ions is hardly occur), thickening ratio=A. Lactam compound
HEP: 1-(2-hydroxyethyl)-2-pyrrolidone
CPL: ε-caprolactam
Water-soluble organic solvent (penetrant)
1,2-Hexanediol
Other solvents
Gly: glycerin
TEG: triethylene glycol
Surfactant
OLFINE E1010 (trade name, acetylene glycol-based surfactant, manufactured by Nissin Chemical Industry Co., Ltd., HLB value=13 to 14)
SURFYNOL 104 (trade name, acetylene glycol-based surfactant, manufactured by Nissin Chemical Industry Co., Ltd., HLB value=4)
Resin
Mowinyl 6820 (trade name, manufactured by Japan Coating Resin Co., Ltd.)
pH Adjuster
TEA: triethylamine

### 3. 2. Evaluation Method

### 3. 2. 1. Thickening Ratio

The ink composition of each example was mixed with an aqueous calcium propionate solution (Ca concentration: 0.3 mol/L) at a ratio of 10:1 (ink:aqueous calcium propionate solution), and the mixture was allowed to stand at 60° C. for 24 hours. The viscosity η1 of the ink after standing and the viscosity η0 of the ink in the initial state were measured as described above, and the thickening ratio was calculated according to the following formula.

Thickening ratio (fold)=ink viscosity after standing η1/initial ink viscosity η0

### Evaluation Criteria

A: Thickening ratio is 1.0 or more and less than 1.5
B: Thickening ratio is 1.5 or more and less than 2.0
C: Thickening ratio is 2.0 or more

### 3. 2. 2. Liquid Mixture Redispersibility

The ink composition of each example was mixed with an aqueous calcium propionate solution (Ca concentration: 0.3 mol/L) at a ratio of 10:1 (ink:aqueous calcium propionate solution), and 5 drops of 2 μl of the liquid mixture were dropped on a slide glass and dried at 60° C. for 24 hours. The slide glass after drying was immersed in a sample bottle containing only the ink composition before mixing, allowed to stand for 3 minutes, then turned upside down 5 times, the slide glass was taken out, and the remaining liquid mixture on the glass and the degree of redissolution were visually determined according to the following criteria.

### Evaluation Criteria

A: All ink droplets redissolve.

B: Ink droplets redissolve, but residue is partly visible on slide glass.

C: Ink droplets do not redissolve and remain in solid state.

D: When an ink composition rated as C was tested again under the same conditions except that the drying temperature was changed to 40° C., ink droplets remain in a solid state as in the case of drying at 60° C.

### 3. 2. 3. Phase Separation in Ink State

The ink composition of each example was put into a glass screw tube, the screw tube was covered with a lid, and the screw tube was allowed to stand in a thermostatic bath at 60° C. for 24 hours. Thereafter, the screw tube was taken out from the thermostatic bath, and it was confirmed whether or not the surfactant was separated by phase separation on the liquid surface of the ink, and the evaluation was performed according to the following criteria.

### Evaluation Criteria

A: No surfactant separation is observed.

B: Surfactant separates and is seen floating on liquid surface.

C: Surfactant is separated and forms two layers.

### 3. 2. 4. Recording Test

A modified machine of LX 10050MF (line type ink jet printer, manufactured by Seiko Epson Corporation) was used. As a head, H1 having an ink landing time difference or H2 having no ink landing time difference was used. Two inks described in Tables 3 to 5 were used in the stated order for filling so that the inks could be ejected.

Then, the two inks were recorded on Copyplus paper (plain paper manufactured by Hammermill Paper Company) in an overlapping manner. The ink droplet mass was 12.5 ng/dot, and the dot density was adjusted by adjusting the number of ink droplets per pixel so that the deposition amount (application amount) in a solid pattern became the above-mentioned value with basic resolution of 600×600 dpi. The transporting speed of the recording medium was 600 mm/s.

The line heads H1 and H2 were configured as follows.

Line head H1: A line head having the nozzle surface 11 shown in FIG. 2. Apparent nozzle density in width direction: 600 npi.

Line head H2: A line head of FIG. 3 in which each unit head is arranged so as to have no straddling portion. Apparent nozzle density in width direction: 600 npi.

The head on the upstream side in the transport direction of the recording medium was filled with an ink to be ejected earlier, and the head on the downstream side is filled with an ink to be ejected later. One unit head had two nozzle rows and was capable of using two inks, but only one of the nozzle rows was used.

### 3. 2. 5. Color Developability

A test pattern of each ink alone was recorded on Copy+ paper (plain paper) by a recording apparatus so that the ink application amount became 5.0 [mg/inch²]. The OD value was measured using a colorimeter (manufactured by X-Rite, Inc., X-Rite i1) and evaluated according to the following criteria.

### Evaluation Criteria

A: OD value is 0.85 or more
B: OD value is 0.75 or more and less than 0.85
C: OD value is 0.65 or more and less than 0.75
D: OD value is less than 0.65

### 3. 2. 6. Ejection Stability

A test pattern of each ink alone was continuously printed by a recording apparatus on 100 sheets of Copy+ paper (A4 plain paper) at the recording speed described in Tables 3 to 5 so that the ink application amount became 5.0 [mg/inch²]. Single-sided printing was performed. After printing, a nozzle check pattern was printed, and it was confirmed whether or not there was printing deviation or omission after the continuous printing.

### Evaluation Criteria

A: No printing deviation or omission occurs.

B: Printing deviation or omission occurs in less than 50% of nozzles.

C: Printing deviation or omission occurs in 50% or more and less than 70% of nozzles.

D: Printing deviation or omission occurs in 70% or more of nozzles.

### 3. 2. 7. Clogging Recoverability

As in the ejection stability test, continuous printing on 100 sheets was performed at the recording speed shown in the tables. Thereafter, in a state where the ink jet head was displaced from the position of the cap provided in the printer and the head was not capped, the printer was allowed to stand for 7 days in an environment at a temperature of 40° C. and a humidity of 20%. After the standing, as cleaning of the ink jet head, every time the suction operation of the ink in the nozzles was performed once, the number of nozzles which could not eject the ink was counted, and the cleaning operation was repeated until all of the nozzles were recovered. Then, based on the number of times of cleaning required until all of nozzles were recovered, evaluation was performed according to the following evaluation criteria. The clogging recoverability is affected by the degree of generation of the dried and solidified matter of ink in nozzles, the composition of the dried and solidified matter, and the like.

### Evaluation Criteria

A: All nozzles were recovered within two cleaning cycles.

B: All nozzles were recovered through three or four cleaning cycles.

C: All nozzles were recovered through five or six cleaning cycles.

D: Unrecovered nozzles were observed even when cleaning was performed six times.

### 3. 2. 8. Visibility of Color Difference Streak

A solid pattern was recorded on an entire recordable region of Copy+ paper (plain paper) with a deposition amount of 7 mg/inch² by the recording apparatus. Equal amounts of the first ink and the second ink were deposited. The visibility of a color difference streak generated in the region where a secondary color was printed (how the color difference streak was seen when visually observed) was evaluated according to the following criteria. The color difference streak is a phenomenon in which a portion having a different color tone looks like a streak, and is likely to occur in a head (H1) having a straddling portion.

A: No color difference streak is seen even when approaching the recorded material to a distance of less than 30 cm.

B: A color difference streak is seen when approaching the recorded material to a distance of less than the 30 cm.

C: A color difference streak is seen on the recorded material even at a distance of 30 cm or more.

### 3. 2. 9. Transfer Properties (Printed Material, Medium Transporting Path)

The recording apparatus and the recording medium were set in an environment in which transfer easily occurs (15° C. and 80% RH) (low temperature and high humidity), and were allowed to settled for 12 hours or more. Thereafter, after it was confirmed that the ink was normally ejected, a nozzle check pattern was printed on 500 sheets by duplex printing. Then, the presence or absence of transfer between printed materials and the presence or absence of contamination (transfer during transportation) in the transporting path were visually checked.

A: No transfer.

B: There is transfer of contamination from the transporting path.

C: There is transfer of contamination between printed materials and from the transporting path.

### 3. 3. Evaluation Results

Referring to Tables 1 to 5, is found that when the ink jet head is a line head having a length equal to or longer than a recording region of the recording medium in a direction intersecting the transport direction, a plurality of first nozzles ejecting a first ink is arranged side by side in the direction intersecting the transport direction, a plurality of second nozzles ejecting a second ink is arranged side by side in the direction intersecting the transport direction, and the ink jet head has a portion in which a time difference between landing of the first ink and landing of the second ink on a certain point of the recording medium varies between portions of the line head in the direction intersecting the transport direction, in each example in which the ink composition includes a red-based ink containing an azo-based pigment as the first ink and a chromatic ink containing a pigment other than the red-based ink as the second ink, the first ink and the second ink are aqueous inks, at least one of the first ink and the second ink has a thickening ratio of less than 2.0 when the ink composition is mixed with an aqueous calcium propionate solution having a Ca concentration of 0.3 mol/L at a mass ratio of 10:1, visibility of a color difference streak on a printed material is good.

In addition, according to the present disclosure, it is found that even when a head in which a landing time difference is caused is used, color difference streaks can be reduced by setting the thickening ratio of the ink to less than 2.0. That is, according to the present disclosure, color difference streaks can be reduced without changing the design of the head.

Although not shown in the tables, when recording was performed using a serial printer (PX-M886L, manufactured by Seiko Epson Corporation, modified machine) instead of the line printer as a recording apparatus, the amount of paper dust generated is smaller than that with the line printer, and the ejection stability and clogging recoverability become high as a whole, but the recording speed is low, and the serial printer is not a useful recording apparatus.

In addition, when evaluation is performed in the same manner as in M1 except that each of HEP and CPL of Ink M1 is replaced with 2-pyrrolidone, the liquid mixture redispersibility and phase separation are deteriorated.

In addition, when evaluation is performed in the same manner as in the Y1 ink except that the content of the pigments in the Y1 ink is reduced, redispersibility of the ink is improved, and ejection stability or the like is also improved. Even in such a case, as the M ink has excellent color developability, excellent color developability can be obtained in recording of an image of a secondary color using a yellow ink and a magenta ink.

The present disclosure includes a configuration substantially the same as the configuration described in the embodiment, for example, a configuration having the same function, method, and result, or a configuration having the same purpose and effect. Further, the present disclosure includes configurations in which non-essential portions of the configuration described in the embodiments are replaced. In addition, the present disclosure includes configurations that provide the same effects as the configurations described in the embodiment or includes configurations that can achieve the same purpose as the configurations described in the embodiment. Further, the present disclosure includes configurations in which a known technology is added to the configurations described in the embodiment.

The following contents are derived from the above-described embodiment and modification examples.

The recording method includes: a transporting step of transporting a recording medium; and an ink deposition step of ejecting an ink composition from an ink jet head to deposit the ink composition onto the recording medium transported in the transporting step, in which the ink jet head is a line head having a length equal to or longer than a recording region of the recording medium in a direction intersecting the transport direction, the ink composition includes a first ink that contains an azo-based pigment and is a red-based ink, and a second ink that contains a pigment and is a chromatic ink other than the red-based ink, each of the first ink and the second ink is an aqueous ink, in the line head, a plurality of first nozzles ejecting the first ink is arranged side by side in the direction intersecting the transport direction, and a plurality of second nozzles ejecting the second ink is arranged in the direction intersecting the transport direction, the line head has a portion in which a time difference between landing of the first ink and landing of the second ink on the recording medium varies between portions of the line head in the direction intersecting the transport direction, and at least one of the first ink and the second ink has a thickening ratio of less than 2.0 when the ink is mixed with an aqueous calcium propionate solution having a Ca concentration of 0.3 mol/L at a mass ratio of 10:1.

According to this recording method, it is possible to obtain a recorded material in which generation of streaks due to a difference in color developability is suppressed. In addition, according to this recording method, it is possible to make color developability of the image by at least the first ink excellent.

The recording medium such as plain paper contains a calcium salt therein. In a case where the ink is an ink having high reactivity with calcium ions, the ink deposited onto the recording medium reacts with calcium ions of the recording medium, and thus the solid content component of the ink is separated from water and forms an aggregate of the solid content. The aggregate of the solid content is solidified over time, and tends to overlap with the ink to make it difficult for the subsequently deposited ink to permeate. Further, due to the aggregate of the solid content reacted with calcium ions, the previously deposited ink itself is difficult to permeate.

On the other hand, in the case of an ink having low reactivity with calcium ions, the solid content of the deposited ink is not separated from water and remains in a dispersed state, and therefore the ink layer is less likely to be solidified even after a lapse of time from the deposition, and the ink subsequently deposited is likely to permeate the ink layer. In addition, the ink itself easily permeates.

In a case where the previously deposited ink is an ink having high reactivity with calcium ions, solidification of the previously deposited ink proceeds in a portion of an image having a large landing time difference between the previously deposited ink and the subsequently deposited ink, and the ink is less likely to permeate the portion. Further, in a case where the ink to be subsequently deposited is also an ink having high reactivity with calcium ions, the ink reacts and the solid content becomes an aggregate, which is difficult to permeate. In addition, the ink subsequently deposited is easily repelled by the previously deposited ink.

In this way, the previously deposited ink and the subsequently deposited ink are not mixed, and the boundary between the deposited inks becomes clear. On the other hand, in a portion of an image where the landing time difference is small, solidification of the previously deposited ink does not proceed, and therefore, the subsequently deposited ink easily permeates the previously deposited ink and is mixed with the previously deposited ink.

As a result, the appearance of the previously deposited ink and the subsequently deposited ink differs between a portion where the landing time difference with respect to the subsequently deposited ink is large and a portion where the landing time difference with respect to the subsequently deposited ink is small, and the color of the image varies. Thus, a color difference streak is generated.

In addition, it is considered that also in a portion in which solidification of the previously deposited ink proceeds and the ink hardly permeates, unreacted calcium remains in the solidified matter, and the subsequently deposited ink reacts with calcium on the previously deposited ink.

On the other hand, when the ink to be subsequently deposited is an ink having low reactivity with calcium ions, the subsequently deposited ink easily permeates. Therefore, the boundary of the inks is blurred and color difference streaks can be reduced. Alternatively, in a case where the ink to be previously deposited is an ink having low reactivity with calcium ions, the solid matter of the ink is less likely to be solidified, and the previously deposited easily permeates. Therefore, the boundary of the inks is blurred, and color difference streaks can be reduced.

Thus, when at least one of the inks is an ink having low reactivity with calcium ions, color difference streaks can be reduced. From the viewpoint of reducing color difference streaks, both inks may be inks having low reactivity with calcium ions.

In the above-described recording method, a content of the azo-based pigment with respect to the total pigment mass contained in the first ink may be 30% by mass or more.

According to this recording method, it is possible to further increase color developability of the first ink. For example, in a case where the first ink is an ink having low reactivity with calcium ions, the ink easily permeates into the recording medium and is not easily retained on a surface of the recording medium, and thus color developability of the ink becomes low. However, in a case where the first ink is, for example, a magenta ink, there are various pigments to be used. In particular, by using an azo-based pigment having high color developability, it is possible to obtain a magenta ink having high color developability even when reactivity of the first ink with calcium ions is low.

The color of the first ink is not limited, but the first ink is, for example, a magenta ink of a process color ink. In particular, in business applications, high visibility of a red mark on a recorded material such as confidential display or seal printing is required, and a magenta ink used for this color is required to have high color developability. In addition, since red is a color that is easily visually recognized, color difference streaks are easily conspicuous. Therefore, it is required to reduce color difference streaks in color recording using a magenta ink, and the present disclosure exhibits a more excellent effect in this respect.

In the above-described recording method, the thickening ratio of the first ink may be less than 2.0 times.

According to this recording method, color developability of the first ink can be further improved.

In the above-described recording method, the first ink may contain a dispersant resin for dispersing the azo-based pigment, and an acid value of the dispersant resin may be 200 mg KOH/g or less.

According to this recording method, color developability of the first ink can be further improved.

In the above-described recording method, each of the first ink and the second ink may contain a lactam having a molecular weight of 100 or more.

Since the line printer prints continuously at high speed and in a large volume, a large amount of paper dust is generated, and paper dust may accumulate inside the printer. For this reason, the paper dust adheres to the nozzles to increase the viscosity, and ejection stability and clogging recoverability tend to be problems. This tendency is particularly noticeable when the ink is highly reactive with calcium. This tendency is also observed even in a case where the ink is less reactive. When the ink is less reactive with calcium, ejection stability and clogging recoverability are excellent. When the paper dust generated during recording comes into contact with the ink in the nozzles, the pigment of the highly reactive ink may turn into foreign matter due to the paper dust. As a result, ejection stability and clogging recoverability may deteriorate. When the ink has low reactivity, this can be suppressed.

According to this recording method, drying of the mixture of the paper dust and the ink in the nozzles is suppressed by the moisture-retaining effect of the lactam, and even when the mixture begins to dry, redispersibility of the dried material can be further improved, and ejection stability and clogging recoverability can be improved. Further, this effect is more effective when the molecular weight is equal to or more than a predetermined value. Furthermore, in a case where the ink contains an acetylene glycol-based surfactant, in particular, lactams are likely to suppress phase separation caused by the acetylene glycol-based surfactant without being dissolved in water. Among the lactams, 1-(2-hydroxyethyl)-2-pyrrolidone (HEP) and ε-caprolactam (CPL) have more remarkable effects. In particular, even when HEP is contained in the ink, the viscosity of the ink tends to be less likely to increase, and thus the ink ejection amount can be easily controlled and stable ejection can be performed. In addition, CPL is particularly excellent in the above-mentioned effect of redispersibility.

In the above-described recording method, the thickening ratio of the other of the first ink and the second ink may be 2.0 or more.

According to this recording method, color difference streaks can be further reduced.

In the above-described recording method, the first ink may be a magenta ink, and the second ink may be a yellow ink or a cyan ink.

According to this recording method, by using, as the magenta ink, an ink using an azo pigment and having low reactivity with calcium, the second ink can be an ink having high reactivity with calcium, and the degree of freedom in design can be increased. Further, for example, by using an ink having high reactivity with calcium as the yellow ink, the visibility of yellow can be improved, which is more preferable. By using the yellow ink having high reactivity with calcium and the magenta ink having low reactivity with calcium in an image of a warm-color-based color in which color difference streaks are likely to be conspicuous, an image having high visibility and reduced color difference streaks can be recorded.

When the second ink is a cyan ink, the reactivity is also preferably high. The cyan ink is often used for generating a secondary color (blue) with the magenta ink (first ink). However, since the reactivity of the magenta ink is low, color difference streaks of blue can be further reduced.

Further, the problem of color difference streaks tends to be more significant between inks used for generating a secondary color (between two inks having adjacent hue angles). If the reactivity of the magenta ink is low, it is possible to increase the reactivity of the yellow and cyan inks in printing of a secondary color (red-based or blue-based color) with the yellow or cyan ink.

In the above-described recording method, the first ink may be deposited after the second ink is deposited.

According to this recording method, the first ink (magenta) is deposited later. As a result, the latter first ink is more likely to be present on the upper side in the ink layer formed after deposition, and thus the color developability of red-based colors tends to be enhanced, which is more preferable in recording of a red-based image.

In the above-described recording method, the recording medium may be an absorptive recording medium.

According to this recording method, since a recording medium in which a pigment is unlikely to remain on the surface is used, the effect of the recording method of improving color developability on a surface becomes more remarkable.

In the above-described recording method, the line head may have a portion in which the inter-nozzle distance between the first nozzle and the second nozzle in the transport direction varies between portions in a direction intersecting the transport direction, and the portion in which the inter-nozzle distance varies may be a portion in which the landing time difference varies.

According to this recording method, even in a situation in which a color difference streak is more likely to occur, it is possible to reduce color difference streaks by using the line head having a portion in which the landing time difference between the first ink and the second ink varies.

The recording apparatus is a recording apparatus which performs any one of the recording methods described above, and includes the ink composition and an ink jet head which ejects the ink composition to deposit the ink composition onto the recording medium transported in the transporting step.

According to this recording apparatus, since at least one ink of the ink composition is an ink having low reactivity with calcium ions, color difference streaks can be reduced.

What is claimed is:

1. A recording method comprising: a transporting step of transporting a recording medium in a transport direction; and
an ink deposition step of ejecting an ink composition from an ink jet head to deposit the ink composition onto the recording medium transported in the transporting step, wherein
the ink jet head is a line head having a length equal to or longer than a recording region of the recording medium in a direction intersecting the transport direction;
the ink composition includes a first ink that contains an azo-based pigment and is a red-based ink, and a second ink that contains a pigment and is a chromatic ink other than the red-based ink;
each of the first ink and the second ink is an aqueous ink;
in the line head, a plurality of first nozzles ejecting the first ink is arranged in the direction intersecting the transport direction, and a plurality of second nozzles ejecting the second ink is arranged in the direction intersecting the transport direction;
the line head has a portion in which a time difference between landing of the first ink and landing of the second ink on the recording medium varies between portions of the line head in the direction intersecting the transport direction; and
at least one of the first ink and the second ink has a thickening ratio of less than 2.0 when the first ink or the second ink is mixed with an aqueous calcium propionate solution having a Ca concentration of 0.3 mol/L at a mass ratio of 10:1.

2. The recording method according to claim 1, wherein
a content of the azo-based pigment is 30% by mass or more with respect to a total pigment mass contained in the first ink.

3. The recording method according to claim 1, wherein
the thickening ratio of the first ink is less than 2.0.

4. The recording method according to claim 3, wherein
the first ink contains a dispersant resin for dispersing the azo-based pigment, and an acid value of the dispersant resin is 200 mg KOH/g or less.

5. The recording method according to claim 1, wherein
the first ink and the second ink each contain a lactam having a molecular weight of 100 or more.

6. The recording method according to claim 1, wherein
the other of the first ink and the second ink has the thickening ratio of 2.0 or more.

7. The recording method according to claim 1, wherein
the first ink is a magenta ink, and the second ink is a yellow ink or a cyan ink.

8. The recording method according to claim 1, wherein
the first ink is deposited after the second ink is deposited.

9. The recording method according to claim 1, wherein
the recording medium is an absorptive recording medium.

10. The recording method according to claim 1, wherein
the line head has a portion in which an inter-nozzle distance between the first nozzle and the second nozzle in the transport direction varies between portions in the direction intersecting the transport direction; and
the portion in which the inter-nozzle distance varies may be a portion in which the time difference in landing varies.

11. A recording apparatus performing the recording method according to claim 1, the apparatus comprising:
the ink composition;
a transporting mechanism that performs the transporting step; and
the ink jet head.
